(19) United States
(12) Patent Application Publication
(10) Pub. No.: US 2016/0212676 A1
(43) Pub. Date: Jul. 21, 2016

(54) BASE STATION, WIRELESS COMMUNICATION SYSTEM, AND WIRELESS COMMUNICATION METHOD

(71) Applicant: FUJITSU LIMITED, Kawasaki-shi (JP)

(72) Inventors: Masakazu KOJIMA, Kawasaki (JP); Hiroaki WATANABE, Kawasaki (JP); Yasuharu IWATA, Sagamihara (JP)

(21) Appl. No.: 14/984,912

(22) Filed: Dec. 30, 2015

(30) Foreign Application Priority Data
Jan. 15, 2015 (JP) 2015-005759

(51) Int. Cl. H04W 36/38; H04W 16/14; H04W 36/32; H04W 36/04; H04W 36/22

(52) U.S. Cl. CPC H04W 36/38; H04W 36/04; H04W 36/22; H04W 36/32; H04W 16/14

(57) ABSTRACT

A base station including: an antenna configured to form a second cell, and a processor configured to: process a control signal with a terminal that is located in an overlapping area of a first cell and the second cell, the first cell being formed by another base station that processes a data signal with the terminal, and transfer processing of the control signal with the terminal to the other base station when a load of the processing of the control signal is more than a first threshold in the base station and when the terminal is located in the overlapping area for more than a given length of time.

### CROSS-REFERENCE TO RELATED APPLICATION

This application is based upon and claims the benefit of priority of the prior Japanese Patent Application No. 2015-005759, filed on Jan. 15, 2015, the entire contents of which are incorporated herein by reference.

### FIELD

The embodiments discussed herein are related to a base station, a wireless communication system, and a wireless communication method.

### BACKGROUND

Currently, a mobile phone system or a wireless communication system of a wireless local area network (LAN) and the like has been widespread used. In the field of wireless communication, the next generation communication technology has been continuously discussed in order to further improve a communication speed or communication capacity. For example, in 3rd Generation Partnership Project (3GPP) which is a standardization organization, standardization of a communication standard referring to long term evolution (LTE) or a communication standard referring to LTE-Advanced (LTE-A) which uses LTE as a base is completed or examined.

Regarding such a wireless communication system, there is a technology referring to a heterogeneous network (HetNet). The HetNet is a technology in which systems having different radiuses of a cell or different wireless communication method are mixed in the same wireless communication area. Thus, for example, it is possible to improve capacity of the entirety of a network in comparison to a wireless communication system other than the HetNet. However, the HetNet is currently used as a wireless communication system in which a small-cell base station having a service area (which may be referred to as “a small cell” below) which has a wireless communication area narrower than that of the macro cell is disposed in a service area (which may be referred to as “a macro cell” below) of a macro-cell base station.

Since the small cell has a service area narrower than that of the macro cell, even when a terminal device moves in a macro cell, handover from the macro-cell base station to the small-cell base station, or handover from the small-cell base station to the macro-cell base station may occur. Accordingly, in a wireless communication system having a configuration of the HetNet, the frequency of occurrence of handover is increased in comparison to a wireless communication system having a configuration other than the HetNet. Thus, processing load in the wireless communication system is also increased.

A technology referring to a C/U separation HetNet has attracted attention. The C/U separation HetNet is, for example, a technology in which regarding a terminal device under the small-cell base station, the small-cell base station performs user data processing (which may refer to “U-Plane processing”, for example) and the macro-cell base station performs processing on a control signal (which may refer to “C-Plane processing”, for example).

In the C/U separation HetNet, since the macro-cell base station performs the C-Plane processing, even when a terminal moves between the macro cell and the small cell, the macro-cell base station and the small-cell base station may not perform processing relating to handover. Accordingly, in the C/U separation HetNet, a control signal relating to handover is not exchanged between the macro-cell base station and the small-cell base station, and the terminal. Thus, it is possible to increase a speed and capacity of data communication.

As a technology of the related art relating to the wireless communication system, for example, there is a technology as follows.

That is, there is a wireless control device in which when congestion occurs, position information and a movement speed of a mobile station are detected, a mobile station which is determined to enable handover is forcibly subjected to handover to a wireless communication system which has a wireless communication area different from a wireless communication area in a congestion state.

According to this technology, portable terminal in the cell can be efficiently distributed and congestion can be settled when congestion occurs or in a state where occurrence of congestion is predicted.

An example of the related art includes Japanese Laid-open Patent Publication No. 2008-270919.

### SUMMARY

According to an aspect of the invention, a base station includes an antenna configured to form a second cell, and a processor configured to: process a control signal with a terminal that is located in an overlapping area of a first cell and the second cell, the first cell being formed by another base station that processes a data signal with the terminal, and transfer processing of the control signal with the terminal to the other base station when a load of the processing of the control signal is more than a first threshold in the base station and when the terminal is located in the overlapping area for more than a given length of time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a wireless communication system;

FIG. 2 is a diagram illustrating a configuration example of the wireless communication system;

FIG. 3 is a diagram illustrating CA between base stations;

FIG. 4 is a diagram illustrating a configuration example of a macro-cell base station;

FIG. 5 is a diagram illustrating a configuration example of a small-cell base station;

FIG. 6 is a diagram illustrating a configuration example of a terminal;

FIG. 7A is a diagram illustrating a configuration example of an MME;

FIG. 7B is a diagram illustrating a configuration example of a S-GW;

FIG. 8 is a flowchart illustrating a monitoring example of a processing quantity of a C-Plane;

FIG. 9 is a flowchart illustrating an operation example of C-Plane processing transition;

FIG. 10 is a sequence diagram illustrating an operation example of C-Plane processing transition;

FIG. 11 is a sequence diagram illustrating an operation example of C-Plane processing transition;

FIG. 12 is a sequence diagram illustrating an operation example of C-Plane processing transition;

FIG. 13 is a sequence diagram illustrating an operation example of C-Plane processing transition;

FIG. 14 is a diagram illustrating a division example of a service area;

FIG. 15 is a diagram illustrating an example of an HO determination matrix;

FIG. 16 is a diagram illustrating a setting example of an SRB and a DRB;

FIG. 17 is a diagram illustrating a setting example of an SRB and a DRB;

FIG. 18 is a diagram illustrating a setting example of an SRB and a DRB;

FIG. 19 is a flowchart illustrating an example of HO frequency calculation processing;

FIG. 20 is a flowchart illustrating an example of the HO frequency calculation processing;

FIG. 21 is a flowchart illustrating an operation example of C-Plane processing transition;

FIG. 22 is a diagram illustrating a configuration example of the macro-cell base station;

FIG. 23 is a diagram illustrating a configuration example of the small-cell base station; and

FIG. 24 is a diagram illustrating a configuration example of the terminal.

### DESCRIPTION OF EMBODIMENTS

However, in the C/U separation HetNet, C-Plane processing congestion may have an influence on the terminal device under the small-cell base station.

That is, in the C/U separation HetNet, the macro-cell base station performs the C-Plane processing on a terminal device under the small-cell base station, in addition to a terminal device under the macro-cell base station. For example, a case where many users (or terminal devices) who (which) move at a high speed on Shinkansen (a bullet train) and the like pass through the macro cell is considered. In this case, the macro-cell base station performs handover processing on the many terminal devices. In the macro-cell base station, an allowable range of the handover processing may be exceeded due to the many terminal devices. In this case, the C-Plane processing for all terminal devices under the macro-cell base station is congested. In this case, since the macro-cell base station performs the C-Plane processing on the terminal under the small-cell base station, congestion has an influence on the terminal device under the macro-cell base station and on the C-Plane processing for the terminal device under the small-cell base station. Thus, in the macro-cell base station, the C-Plane processing may have an influence on the terminal device under the small-cell base station.

In a HetNet configuration which is not a C/U separation type, the macro-cell base station performs the C-Plane processing on a terminal device under the macro-cell base station, and the small-cell base station performs the C-Plane processing on a terminal device under the small-cell base station, and thus the processing is performed on the terminal devices which are separated from each other. Therefore, congestion of the C-Plane processing in the macro-cell base station does not have an influence on congestion of the C-Plane processing in the small-cell base station.

In the technology in which handover is forcibly performed on a wireless communication system having a wireless communication area different from a wireless communication area in the above-described congestion state, a congestion state of a handover source in the wireless communication system can be avoided, but congestion of a handover destination in the wireless communication system has no consideration. Accordingly, in this technology, the C-Plane processing of the handover destination in the wireless communication system may be congested.

The disclosure is to provide a base station device and a wireless communication system in which congestion for processing on the control signal is avoided.

Hereinafter, embodiments will be described.

### First Embodiment

A first embodiment will be described.

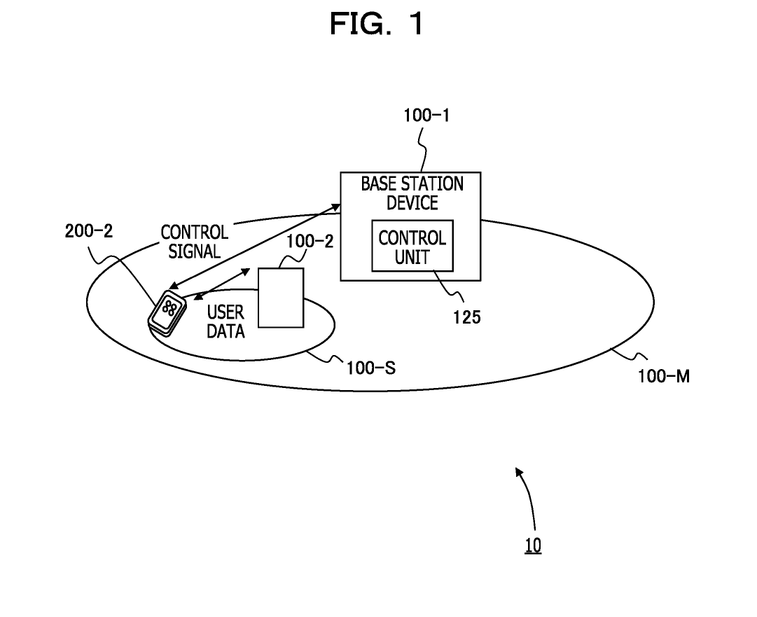

FIG. 1 is a diagram illustrating a configuration example of a wireless communication system 10. The wireless communication system 10 includes a base station device 100-1, another base station device 100-2, and a terminal 200-2.

The base station device 100-1 has a second service area 100-M. The other base station device 100-2 has a first service area 100-S. The second service area 100-M includes the first service area 100-S and has an area wider than the first service area 100-S.

The base station device 100-1 exchanges a control signal with the terminal device 200-2 which stays in the first service area 100-S. The other base station device 100-2 exchanges user data with the terminal device 200-2 which stays in the first service area 100-S.

The wireless communication system 10 is a C/U separation HetNet, for example.

The base station device 100-1 includes a control unit 125. The control unit 125 causes processing on a control signal of a terminal device 200-2 to be transitioned to the base station device 100-2 from the base station device 100-1 when the terminal device 200-2 has a processing quantity for the control signal which is equal to or greater than a first threshold, and stays in the first service area 100-S for a period which is equal to or longer than a predetermined period of time.

Thus, the processing on the control signal for the terminal device 200-2 staying in the first service area 100-S is transitioned to the other base station device 100-2 from the base station device 100-1. Accordingly, in the base station device 100-1, the processing on the control signal is not performed for the terminal device 200-2, and thus it is possible to avoid congestion on control signal processing in the base station device 100-1.

### Second Embodiment

Next, a second embodiment will be described.

Configuration Example of Wireless Communication System

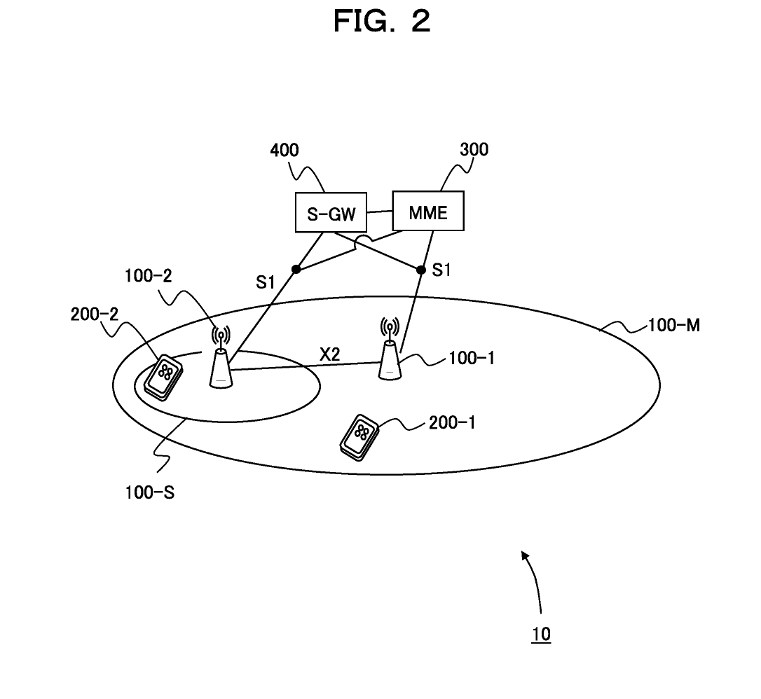

A configuration example of the wireless communication system will be described. FIG. 2 is a diagram illustrating the configuration example of the wireless communication system 10. The wireless communication system 10 includes the macro-cell base station device (or a first base station device, which may refer to “a macro-cell base station” below) 100-1 and the small cell base station device (or a second base station device, which may refer to “a small-cell base station” below) 100-2. The wireless communication system 10 includes the terminal devices (which may refer to “a terminal” below) 200-1 and 200-2, a mobility management entity (MME) 300, and a Serving Gateway (S-GW) 400.

The service area 100-M of the macro-cell base station 100-1 is wider than the service area 100-S of the small-cell base station 100-2. The service area 100-S of the small-cell base station 100-2 is hierarchically disposed in the service area 100-M of the macro-cell base station 100-1. In this manner, the wireless communication system in which the service area 100-S is hierarchically disposed in the service area 100-M may refer to a HetNet, for example. The wireless communication system 10 in FIG. 2 is an example of the HetNet.

The macro-cell base station 100-1 performs wireless communication with the terminals 200-1 and 200-2 which stay in the service area 100-M, and exchanges user data, a control signal, and the like with the terminals 200-1 and 200-2.

The macro-cell base station 100-1 is connected to the small-cell base station 100-2, the MME 300, and the S-GW 400. The macro-cell base station 100-1 exchanges user data, a control signal, and the like with the small-cell base station 100-2 by using an X2 interface. The macro-cell base station 100-1 exchanges a control signal, user data, and the like with the MME 300 or the S-GW 400 by using an S1 interface.

In the following descriptions, a function group relating to an exchange of user data may refer to a U-Plane (or user plane), and a function group which relates to call control and relates to an exchange of a control signal may refer to a C-Plane (or control plane). User data such as sound data and text data is exchanged (transmitted) by using the U-Plane. A control signal relating to call control is exchanged by using the C-Plane.

The small-cell base station 100-2 performs wireless communication with the terminal 200-2 staying in the service area 100-S so as to exchange user data, a control signal and the like.

The small-cell base station 100-2 is connected to the macro-cell base station 100-1, the MME 300, and the S-GW 400. The small-cell base station 100-2 exchanges user data or a control signal with the macro-cell base station 100-2 by using the X2 interface. The small-cell base station 100-2 exchanges a control signal or user data with the MME 300 or the S-GW 400 by using the S1 interface.

In this wireless communication system 10, the small-cell base station 100-2 performs the U-Plane processing for the terminal 200-2 which stays in the service area 100-S of the small-cell base station 100-2 and the macro-cell base station 100-2 performs the C-Plane processing.

In this manner, a HetNet in which the small-cell base station 100-2 performs the U-Plane processing, and the macro-cell base station 100-1 performs the C-Plane processing may refer to a C/U separation HetNet, for example. FIG. 2 illustrates an example of the wireless communication system 10 of the C/U separation HetNet.

The terminals 200-1 and 200-2 are, for example, portable mobile terminals such as a feature phone, a smart phone, and a personal computer. The terminal 200-1 exchanges user data with the macro-cell base station 100-1, and thus it is possible to receive provision of various services such as a call service and an image distribution service. The terminal 200-2 exchanges user data with the small-cell base station 100-2, and thus it is possible to receive provision of various services such as a call service from the small-cell base station 100-2.

The MME 300 is a management apparatus, for example, which performs position management of the terminals 200-1 and 200-2 or performs bearer control and the like. A bearer is, for example, a logical path which is established between the terminals 200-1 and 200-2, and the S-GW 400, and on which user data or a control signal is transmitted. For example, a logical path for transmitting user data may refer to a data bearer (or a data radio bearer (DRB)), and a logical path for transmitting a control signal may refer to a signal bearer (or a signal radio bearer (SRB)).

The DRB is set between the S-GW 400, and the terminals 200-1 and 200-2, and thus user data is exchanged (or transmitted) between the S-GW 400 and the terminals 200-1 and 200-2 by using the U-Plane. The SRB is set between the S-GW 400, and the terminals 200-1 and 200-2, and thus a control signal is exchanged between the S-GW 400 and the terminals 200-1 and 200-2 by using the C-Plane.

The MME 300 leads setting of a bearer. For example, the MME 300 sets the signal bearer and instructs the S-GW 400 of setting of the data bearer. The S-GW 400 receives this instruction and sets the data bearer.

The S-GW 400 exchanges user data and a control signal with the macro-cell base station 100-1 or the small-cell base station 100-2. The S-GW 400 transmits user data to the macro-cell base station 100-1 or the small-cell base station 100-2 in accordance with the set DRB. The S-GW 400 transmits a control signal to the macro-cell base station 100-1 or the small-cell base station 100-2 in accordance with the set SRB.

As described above, this wireless communication system 10 is the C/U separation HetNet. As one form of the C/U separation HetNet, for example, there is carrier aggregation (CA) (or Inter-eNB CA) between the base stations. The HetNet wireless communication system 10 may be, for example, the C/U separation HetNet by setting CA between the base stations.

CA between the base stations is, for example, a technology in which a frequency band used in transmission and reception of a radio signal in the macro-cell base station 100-1 and a frequency band used in transmission and reception of a radio signal in the small-cell base station 100-2 are put together (or collected) and used as one frequency band. For example, in CA between the base stations, since the frequency bands of both of the macro-cell base station 100-1 and the small-cell base station 100-2 may be simultaneously used, it is possible to increase capacity and a speed in communication.

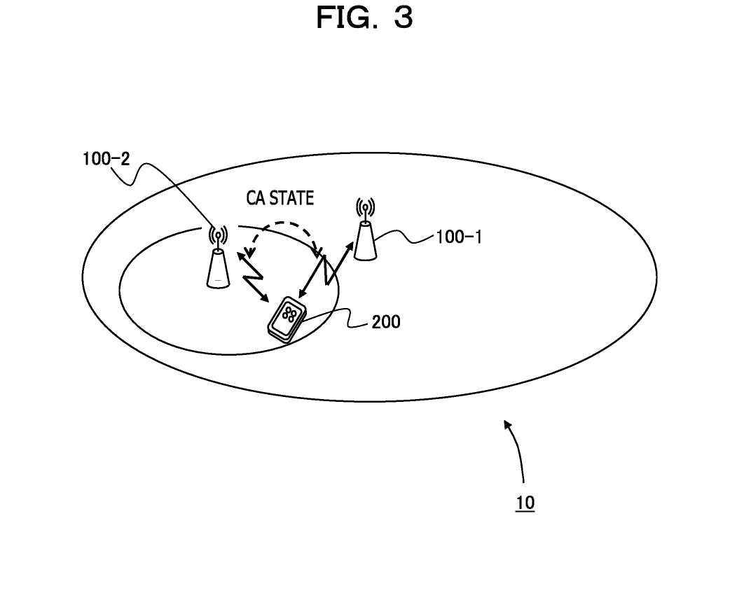

FIG. 3 illustrates an example of the wireless communication system 10 when CA between the base stations is performed. In this case, two DRBs which are a DRB via the macro-cell base station 100-1, and a DRB via the small-cell base station 100-2 are set for the terminal 200. The SRB is set between the terminal 200 and the macro-cell base station 100-1. The U-Plane is set in the small-cell base station 100-2, and the C-Plane is set in the macro-cell base station 100-1. The wireless communication system 10 illustrated in FIG. 3 includes the C/U separation HetNet.

Next, configuration examples of the macro-cell base station 100-1, the small-cell base station 100-2, the terminal 200, the MME 300, and the S-GW 400 will be described.

Configuration Example of Macro-Cell Base Station

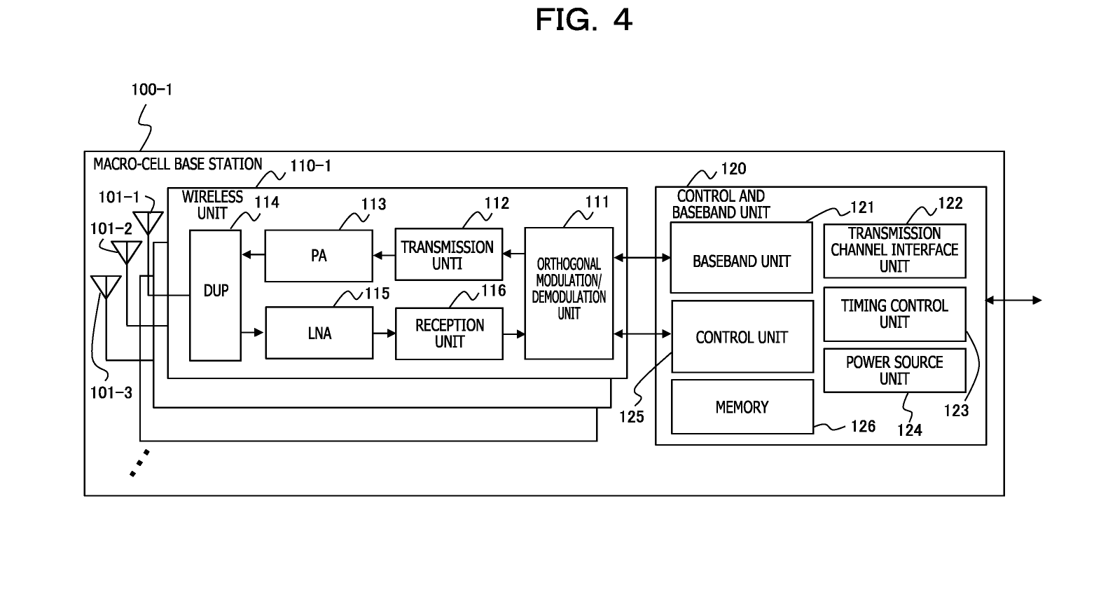

FIG. 4 is a diagram illustrating a configuration example of the macro-cell base station 100-1. The macro-cell base station 100-1 includes a plurality of antennae 101-1, 101-2, . . . , a plurality of wireless units 110-1, 110-2, . . . , and a control and baseband unit 120.

Since all of the plurality of wireless units 110-1, 110-2, . . . , have the same configuration, representatively, descriptions will be made by using the wireless unit 110-1 as an example.

The wireless unit 110-1 includes an orthogonal modulation/demodulation unit 111, a transmission unit 112, a power amplifier (PA) 113, a duplexer (DUP) 114, a low noise amplifier (LNA) 115, and a reception unit 116.

The orthogonal modulation/demodulation unit 111 modulates a baseband signal output from the control and baseband unit 120 and outputs the modulated baseband signal to the transmission unit 112. The orthogonal modulation/demodulation unit 111 demodulates a baseband signal output from the reception unit 116 and outputs the demodulated baseband signal to the control and baseband unit 120.

The transmission unit 112 performs conversion into a radio signal in a wireless band by performing frequency conversion processing and the like on the demodulated baseband signal.

The PA 113 is an amplifier and amplifies the radio signal output from the transmission unit 112.

The DUP 114 outputs the radio signal output from the PA 113 to the antenna 101-1 and outputs the radio signal (reception signal) which is received by the antenna 101-1 to the LNA 115.

The LNA 115 is a low-noise amplifier and amplifies the reception signal output from the DUP 114.

The reception unit 116 performs conversion into a baseband signal in a baseband band by performing frequency conversion processing and the like on the reception signal output from the LNA 115.

The control and baseband unit 120 includes a baseband unit 121, a transmission channel interface unit 122, a timing control unit 123, a power source unit 124, a control unit 125, and a memory 126.

The baseband unit 121 receives user data from the transmission channel interface unit 122, performs error correction encoding processing and the like on the received user data, and performs conversion into a baseband signal. The baseband unit 121 outputs the baseband signal to the orthogonal modulation/demodulation unit 111. The baseband unit 121 receives a control signal from the control unit 125, performs the error correction encoding processing and the like on the control signal, and outputs the baseband signal to the orthogonal modulation/demodulation unit 111.

The baseband unit 121 performs error correction decoding processing and the like on the baseband signal output from the orthogonal modulation/demodulation unit 111, and extracts user data, a control signal, or the like. The baseband unit 121 outputs the extracted user data to the memory 126 or the transmission channel interface unit 122, and outputs the extracted control signal to the control unit 125.

The transmission channel interface unit 122 exchanges a message and the like in an S1 format with the MME 300 or the S-GW 400 and exchanges a message and the like in an X2 format with the small-cell base station 100-2.

Thus, the transmission channel interface unit 122 converts user data or a control signal which is received from the baseband unit 121 or the control unit 125 into a message and the like of the S1 format, and transmits the converted message to the MME 300 or the S-GW 400. The transmission channel interface unit 122 converts user data or a control signal which is received from the baseband unit 121 or the control unit 125 into a message and the like of the X2 format, and transmits the converted message to the small-cell base station 100-2.

The transmission channel interface unit 122 extracts user data or a control signal from the message of the S1 format received from the MME 300 or the S-GW 400, and outputs the extracted user data or control signal to the baseband unit 121, the control unit 125, or the memory 126. The transmission channel interface unit 122 extracts user data or a control signal from the message of the X2 format received from the small-cell base station 100-2, and outputs the extracted user data or control signal to the baseband unit 121, the control unit 125, or the memory 126.

The timing control unit 123 synchronizes other devices such as the terminal 200, the small-cell base station 100-2, and the S-GW 400 and operates each of the units 110-1 and the like in the macro-cell base station 100-1, and the like.

The power source unit 124 causes power of the macro-cell base station 100-1 to turn ON or OFF, for example.

The control unit 125 performs, for example, scheduling for allocation of radio resources, an error correction encoding method, a modulation method, and the like on the terminal 200 under the macro-cell base station 100-1, and generates a control signal including a result of scheduling.

The control unit 125 monitors a processing quantity of the control signal, and causes processing on a control signal of the terminal 200-2 which stays in the service area 100-S for a period which is equal to or longer than the predetermined period of time to be transitioned to the small-cell base station 100-2 from the macro-cell base station 100-1. At this time, the processing quantity of the control signal is equal to or greater than the first threshold. Details thereof will be described in an operation example.

The memory 126 stores user data and the like output from the baseband unit 121 or the transmission channel interface unit 122. An HO determination matrix 1261 is stored in the memory 126. Details of the HO determination matrix 1261 will be described later.

Configuration Example of Small-Cell Base Station

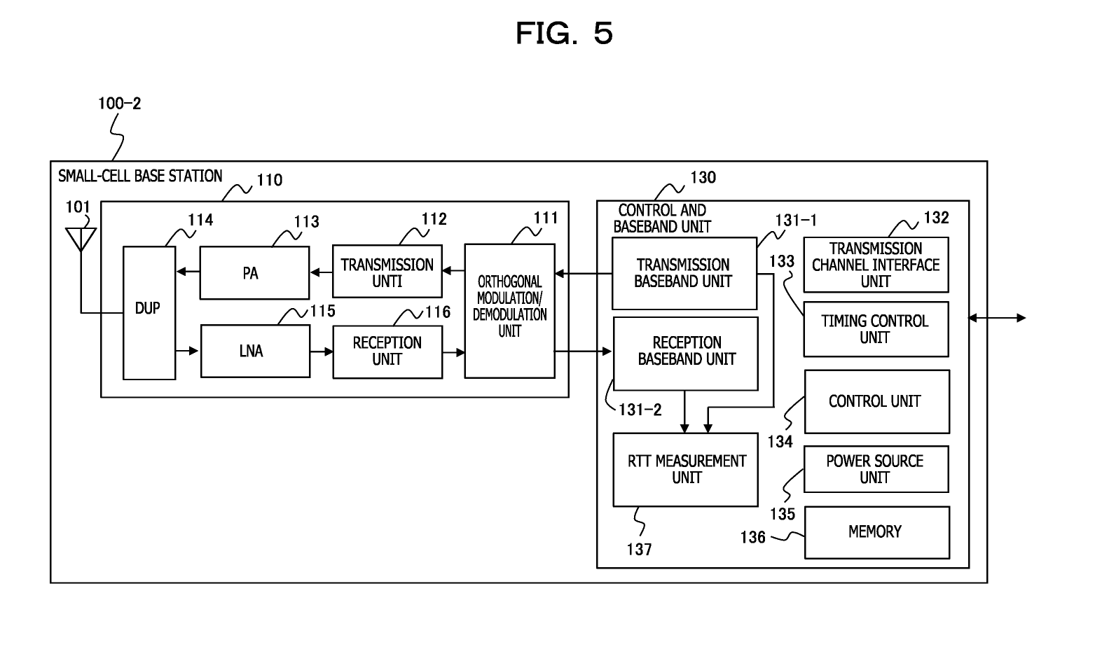

FIG. 5 is a diagram illustrating a configuration example of the small-cell base station 100-2. The small-cell base station 100-2 includes an antenna 101, a wireless unit 110, and a control and baseband unit 130.

The antenna 101 and the wireless unit 110 have the same configurations as those in the macro-cell base station 100-1. The macro-cell base station 100-1 includes a plurality of wireless units 110. However, the small-cell base station 100-2 includes “one” wireless unit 110.

The control and baseband unit 130 includes a transmission baseband unit 131-1, a reception baseband unit 131-2, a transmission channel interface unit 132, a timing control unit 133, a control unit 134, a power source unit 135, a memory 136, and an RTT measurement unit 137.

The transmission baseband unit 131-1 performs error correction encoding processing and the like on user data or a control signal received from the transmission channel interface unit 132 or the control unit 134, and outputs a result of the error correction encoding processing as a baseband signal to the orthogonal modulation/demodulation unit 111.

The reception baseband unit 131-2 performs error correction decoding processing and the like on the baseband signal received from the orthogonal modulation/demodulation unit 111. The reception baseband unit 131-2 extracts and outputs user data or a control signal to the transmission channel interface unit 132, the control unit 134, or the memory 136.

The transmission channel interface unit 132, the timing control unit 133, the power source unit 135, and the memory 136 have the same functions as those of the transmission channel interface unit 122, the timing control unit 123, the power source unit 124, and the memory 126 of the macro-cell base station 100-1. The transmission channel interface unit 122 exchanges user data, a control signal, or the like with the macro-cell base station 100-1 in the X2 format, and exchanges user data, a control signal, or the like with the MME 300 or the S-GW 400 in the S1 format.

The RTT measurement unit 137 measures round trip time (RTT; period of time from transmission of a radio signal until reception) for a radio signal which is transmitted and received between the small-cell base station 100-2 and the terminal 200. A measuring method will be described in an operation example. The RTT measurement unit 137 outputs the measured RTT to the control unit 134.

The control unit 134 estimates a straight distance from the small-cell base station 100-2 to the terminal 200 based on the RTT. The small-cell base station 100-2 estimates a straight distance to the terminal 200, and thus estimates (or determines) a position of the terminal 200, for example. Details thereof will be described later.

Configuration Example of Terminal

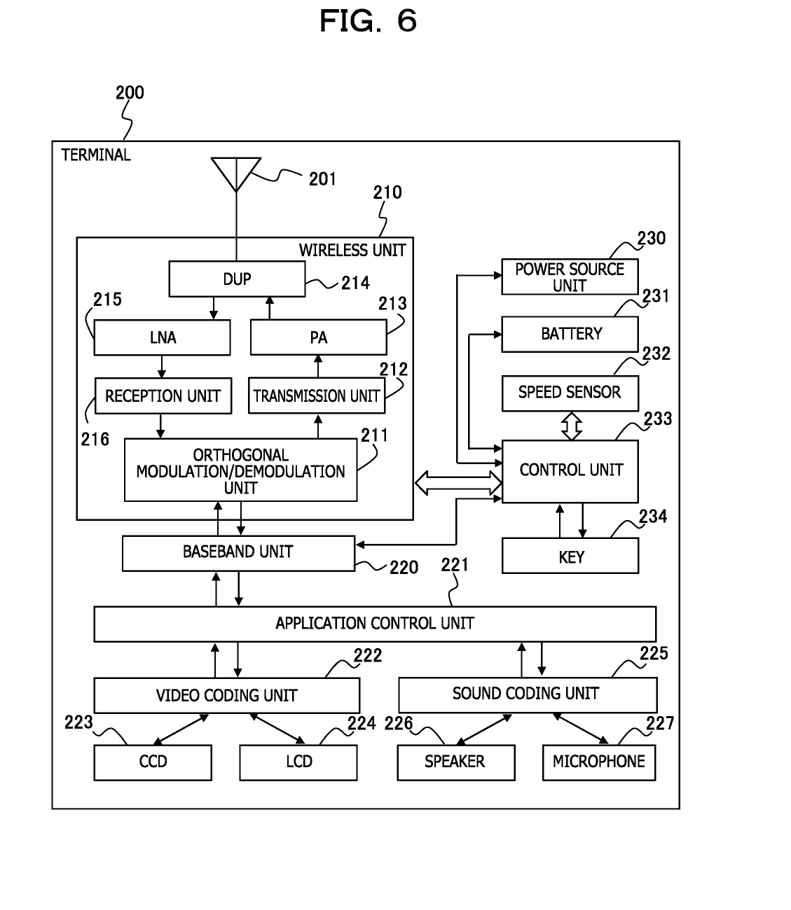

FIG. 6 is a diagram illustrating a configuration example of the terminal 200. The terminal 200 includes an antenna 201, a wireless unit 210, a baseband unit 220, an application control unit 221, a video coding unit 222, a charge coupled device (CCD) 223, and a liquid crystal device (LCD) 224. The terminal 200 includes a sound coding unit 225, a speaker 226, a microphone 227, a power source unit 230, a battery 231, a speed sensor 232, a control unit 233, and a key 234.

The antenna 201 transmits a radio signal output from the wireless unit 210 to the macro-cell base station 100-1 or the small-cell base station 100-2. The antenna 201 receives a radio signal transmitted from the macro-cell base station 100-1 or the small-cell base station 100-2, and outputs the received radio signal to the wireless unit 210.

The wireless unit 210 includes an orthogonal modulation/demodulation unit 211, a transmission unit 212, a PA 213, a DUP 214, an LNA 215, and a reception unit 216. The functions of the orthogonal modulation/demodulation unit 211, the transmission unit 212, the PA 213, the DUP 214, the LNA 215, and the reception unit 216 are the same as that of the wireless unit 110 in the macro-cell base station 100-1 or the small-cell base station 100-2, for example. The functions of the baseband unit 220 and the power source unit 230 are the same as those of the baseband unit 121 and the power source unit 124 in the macro-cell base station 100-1, for example.

For example, the application control unit 221 receives user data from the baseband unit 220, outputs image data in the received user data to the video coding unit 222, and outputs sound data in the received user data to the sound coding unit 225. The application control unit 221 outputs, for example, image data or sound data which is output from the video coding unit 222 or the sound coding unit 225, as user data to the baseband unit 220.

The video coding unit 222 performs image processing such as compression encoding processing on image data output from the CCD 223, and outputs the image data subjected to the image processing to the application control unit 221. The video coding unit 222 performs expansion processing on the compressed image data which is received from the application control unit 221, and outputs the expanded image data to the LCD 224.

The CCD 223 is an imaging element, for example. The CCD 223 generates image data by photographing a subject, and outputs the generated image data to the video coding unit 222. The LCD 224 is a display unit, for example. The LCD 224 displays image data from the video coding unit 222.

The sound coding unit 225 performs sound processing such as compression encoding on sound data received from the microphone 227, and outputs the sound data subjected to the sound processing to the application control unit 221. The sound coding unit 225 performs expansion processing and the like on sound data received from the application control unit 221, and outputs the sound data subjected to the expansion processing to the speaker 226.

The speaker 226 outputs sound corresponding to the sound data received from the sound coding unit 225. The microphone 227 outputs acquired sound as sound data to the sound coding unit 225.

The power source unit 230 supplies power to each of the units in the terminal 200. The battery 231 stores electricity supplied from the power source unit 230. The battery 231 supplies the stored electricity to each of the units in the terminal 200 when power from the power source unit 230 is not supplied. The speed sensor 232 is a sensor of detecting a movement speed of the terminal 200.

The control unit 233 appropriately controls the wireless unit 210 and the baseband unit 220, for example, so as to transmit an instruction of a coding rate of error correction encoding processing in the baseband unit 220, or an instruction of a modulation method of orthogonal modulation encoding in the wireless unit 210, and the like. The control unit 233 receives information regarding the SRB or the DRB which is set by the MME 300 or the S-GW 400. At this time, the control unit 233 controls the wireless unit 210 and the like to transmit a control signal or user data to the macro-cell base station 100-1 or the small-cell base station 100-2, in accordance with the information regarding the SRB or the DRB. The control unit 233 controls the wireless unit 210 and the like to receive a control signal or user data from the macro-cell base station 100-1 or the small-cell base station 100-2, in accordance with the information regarding the SRB or the DRB.

Configuration Example of MME

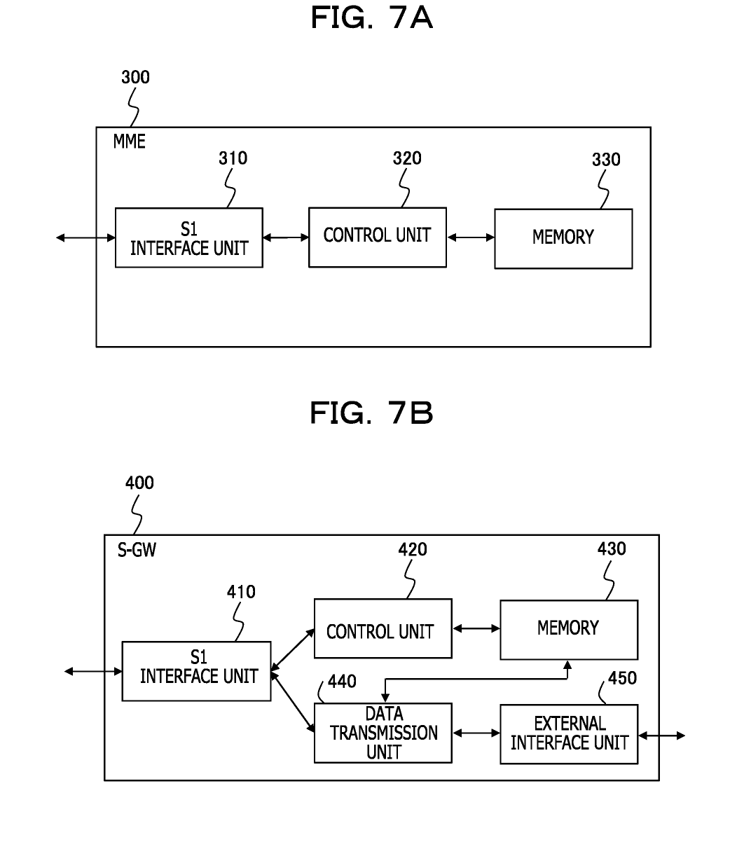

FIG. 7A is a diagram illustrating a configuration example of the MME 300. The MME 300 includes an S1 interface unit 310, a control unit 320, and a memory 330.

The S1 interface unit 310 is connected to the macro-cell base station 100-1, the small-cell base station 100-2, the S-GW 400, and the like, and exchanges a message of the S1 format with these devices. In this case, the S1 interface unit 310 extracts a control signal and the like from the message of the S1 format which is transmitted from the two base stations 100-1 and 100-2 or the S-GW 400. The S1 interface unit 310 outputs the extracted control signal and the like to the control unit 320. The S1 interface unit 310 converts a control signal and the like output from the control unit 320 into a message of the S1 format, and outputs the converted control signal and the like to the two base stations 100-1 and 100-2 or the S-GW 400.

The control unit 320 leads setting of a bearer, for example. For example, the control unit 320 sets the SRB and asks the S-GW 400 to set the DRB. In the second embodiment, the MME 300 sets the SRB and the S-GW 400 sets the DRB.

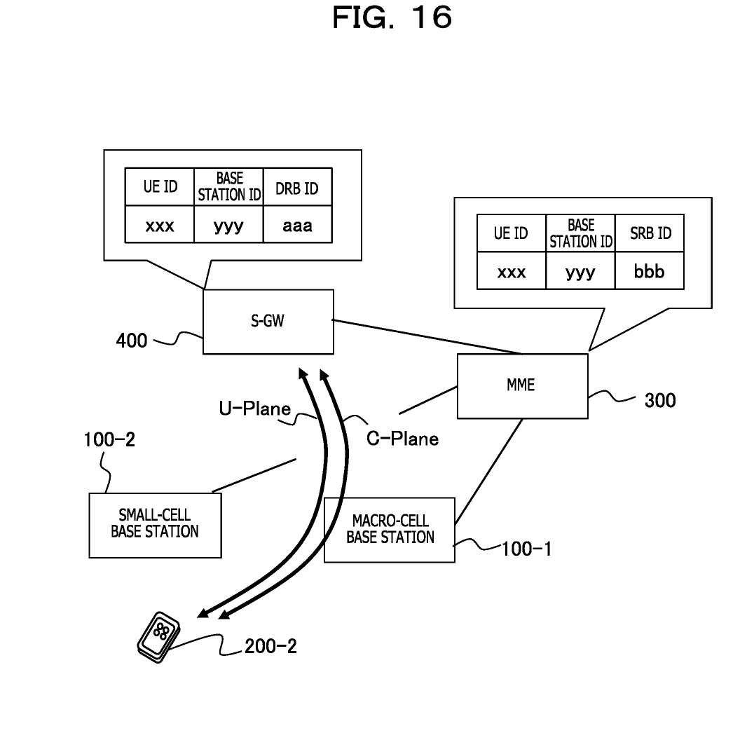

For example, the SRB is set as follows. That is, in the example of FIG. 2, as a path on which a control signal is transmitted by using the C-Plane, there are two paths of a path from the S-GW 400 to the terminal 200-2 through the macro-cell base station 100-1, and a path from the S-GW 400 to the terminal 200-2 through the small-cell base station 100-2. The control unit 320 may set either of the two paths as a path on which the control signal is transmitted by using the C-Plane. In this case, the control unit 320 assigns identification (ID or “identifier”) relating to the SRB to either of the paths and causes the assigned identification to be stored in the memory 330. FIG. 16 is a diagram illustrating an example of setting the SRB. In the example of FIG. 16, the MME 300 assigns “1” as an ID of the SRB to an ID “xxx” of the terminal 200-2 and an ID “yyy” of the macro-cell base station 100-1. Thus, for example, the bearer of the SRB “1” is set in a path from the terminal 200-2 to the S-GW 400 through the macro-cell base station 100-1. The control signal is transmitted on this path by using the C-Plane. The control unit 320 transmits information regarding the set SRB to the terminal 200.

The memory 330 stores information regarding the set SRB, for example. In the example of FIG. 16, a UEID “xxx”, a base station ID “yyy”, and an SRB ID “bbb” are stored in the memory 330.

Configuration Example of S-GW

FIG. 7B is a diagram illustrating a configuration example of the S-GW 400. The S-GW 400 includes an S1 interface unit 410, a control unit 420, a memory 430, a data transmission unit 440, and an external interface unit 450.

The S1 interface unit 410 is connected to the macro-cell base station 100-1, the small-cell base station 100-2, and the MME 300, and receives a message of the S1 format which is transmitted from these devices. The S1 interface unit 410 extracts a control signal from the received message, and outputs the extracted control signal to the control unit 420. The S1 interface unit 410 extracts transmission destination information of the received message from the message including user data, and outputs the transmission destination information to the data transmission unit 440.

The S1 interface unit 410 converts the control signal output from the control unit 420 into a message of the S1 format and transmits the converted message to the macro-cell base station 100-1, the small-cell base station 100-2, or the MME 300. The S1 interface unit 410 transmits a message including the received user data to a transmission destination in accordance with an instruction from the data transmission unit 440.

The control unit 420 sets a call, for example. Generation of a control signal relating to the C-Plane, generation of a response signal to the control signal relating to the C-Plane, and the like are included in setting of a call. If a control signal indicating an instruction of setting the DRB is received from the MME 300, the control unit 420 sets the DRB in accordance with the instruction.

For example, the DRB is set as follows. That is, in the example of FIG. 2, as a path on which user data is transmitted by using the U-Plane, there are two paths of a path from the S-GW 400 to the terminal 200-2 through the macro-cell base station 100-1, and a path from the S-GW 400 to the terminal 200-2 through the small-cell base station 100-2. The control unit 420 may set either of the two paths as a path on which the user data is transmitted by using the U-Plane. In this case, the control unit 420 assigns an ID relating to the DRB to either of the paths and causes the assigned ID to be stored in the memory 430. FIG. 16 is a diagram illustrating an example of setting the DRB. In the example of FIG. 16, the S-GW 400 assigns “1” as an ID of the DRB to an ID “xxx” of the terminal 200-2 and an ID “yyy” of the macro-cell base station 100-1. Thus, for example, the bearer of the DRB “1” is set in a path from the terminal 200-2 to the S-GW 400 through the macro-cell base station 100-1. The user data is transmitted on this path by using the U-Plane. The control unit 420 transmits information regarding the set DRB to the terminal 200.

The control unit 420 may set the DRB for a higher device regarding setting of the DRB.

The memory 430 stores information regarding the set DRB, for example. In the example of FIG. 16, a UEID “xxx”, a base station ID “yyy”, and a DRB ID “aaa”, and the like are stored in the memory 430.

The data transmission unit 440 confirms a transmission destination in accordance with the information regarding the DRB stored in the memory 430, based on the transmission destination information. The data transmission unit 440 instructs the S1 interface unit 410 to perform transmission to the transmission destination through the macro-cell base station 100-1 or the small-cell base station 100-2.

Operation Example

Next, an operation example will be described. The operation example will be described by using an example of FIG. 2. The service area 100-M of the macro-cell base station 100-1 and the service area 100-S of the small-cell base station 100-2 are hierarchically disposed. The terminal 200-2 stays in the service area 100-S of the small-cell base station 100-2. In this case, the macro-cell base station 100-1 determines whether or not the C-Plane processing for the terminal 200-2 is transitioned to the small-cell base station 100-2.

The operation example includes 1) monitoring of a C-Plane processing quantity, 2) transition determination and transition processing of the C-Plane processing. The operation example will be described in this order.

1. Monitoring of Processing Quantity of C-Plane

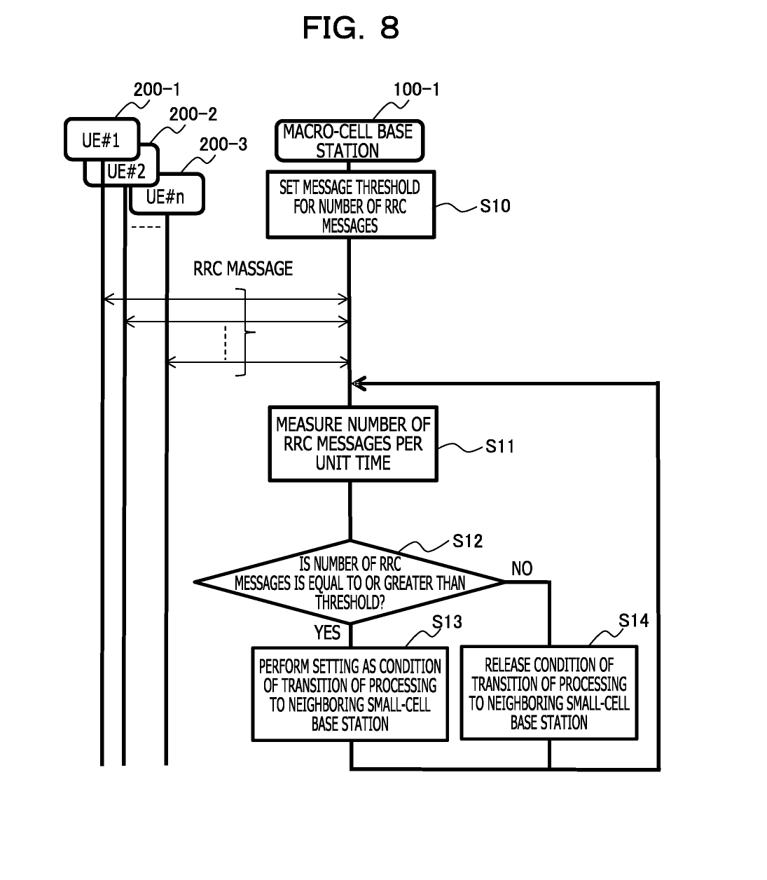

FIG. 8 is a flowchart illustrating a monitoring example of the processing quantity in the C-Plane processing.

The macro-cell base station 100-1 sets a message threshold for the number of RRC messages (S10). For example, the message threshold is set through an input device such as a keyboard by a manager who manages the macro-cell base station 100-1, or an operator. The message threshold is recorded in the memory 126. The message threshold may be appropriately corrected or changed.

Then, the macro-cell base station 100-1 measures the number of RRC messages per unit time (S11). For example, the control unit 125 measures the number of baseband signals relating to the RRC messages output from the wireless units 110-1, . . . , for a predetermined period of time. Thus, the control unit 125 measures the number of RRC messages per unit time.

Then, the macro-cell base station 100-1 determines whether or not the number of RRC messages is equal to or greater than the message threshold (S12). For example, the control unit 125 performs determination by comparing the measured number of RRC messages per unit time and the message threshold read from the memory 126.

When the number of RRC messages is equal to or greater than the message threshold (YES in S12), the macro-cell base station 100-1 performs transition determination and transition processing of the C-Plane processing as a condition of moving to the neighboring small-cell base station 100-2 (S13). The process of S13 corresponds to the above-described “2) transition determination and transition processing of the C-Plane”.

When the number of RRC messages is less than the message threshold (NO in S12), the macro-cell base station 100-1 releases the condition of moving to the neighboring small-cell base station 100-2 (S14). In this case, the macro-cell base station 100-1 does not perform “2) transition determination and transition processing of the C-Plane”.

2. Transition Determination And Transition Processing of C-Plane

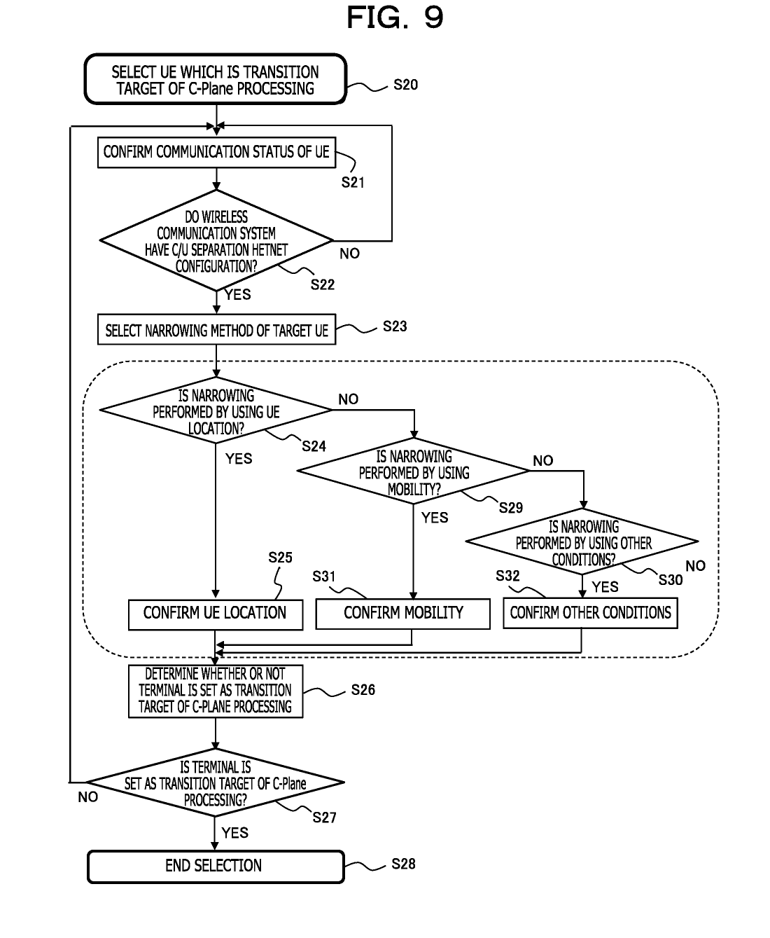

Next, the transition determination and the transition processing of the C-Plane will be described. FIGS. 9 to 18 are diagrams illustrating the transition determination and the transition processing of the C-Plane. Among these drawings, FIG. 9 illustrates an example of the entire processing of the transition determination and the transition processing.

In FIG. 9, processing for selecting a method used for narrowing the terminal 200-2 which is a target causing the C-Plane processing to be transitioned is also included. A narrowing method may be one method or a method in combination of methods. In the second embodiment, narrowing is performed by combining a location and mobility of the terminal 200-2. For example, it is possible to set the terminal 200-2 which continuously stays in the service area of the small-cell base station 100-2 for a period which is equal to or longer than the predetermined period of time, as a target terminal which causes the C-Plane processing to be transitioned.

As illustrated in FIG. 9, if the process is started (S20), the macro-cell base station 100-1 confirms a communication status of the terminal 200 (S21), and determines whether or not the wireless communication system 10 has the C/U separation HetNet configuration (S22).

When it is determined that the wireless communication system 10 does not have the C/U separation HetNet configuration (NO in S22), the macro-cell base station 100-1 causes the process to proceed to S21 and waits until the wireless communication system 10 has the C/U separation HetNet configuration.

When it is determined that the wireless communication system 10 has the C/U separation HetNet configuration (YES in S22), the macro-cell base station 100-1 selects a narrowing method for the terminal 200 which is a C-Plane transition target (S23).

As the narrowing method, a position of the terminal 200 (“narrowing by using a UE location”), mobility of the terminal 200-2 (“narrowing by using mobility”), and other conditions (“narrowing by using other conditions”) are used. As the narrowing method, any of the three methods may be used or combination of these methods may be used (S24 to S25 and S29 to S32).

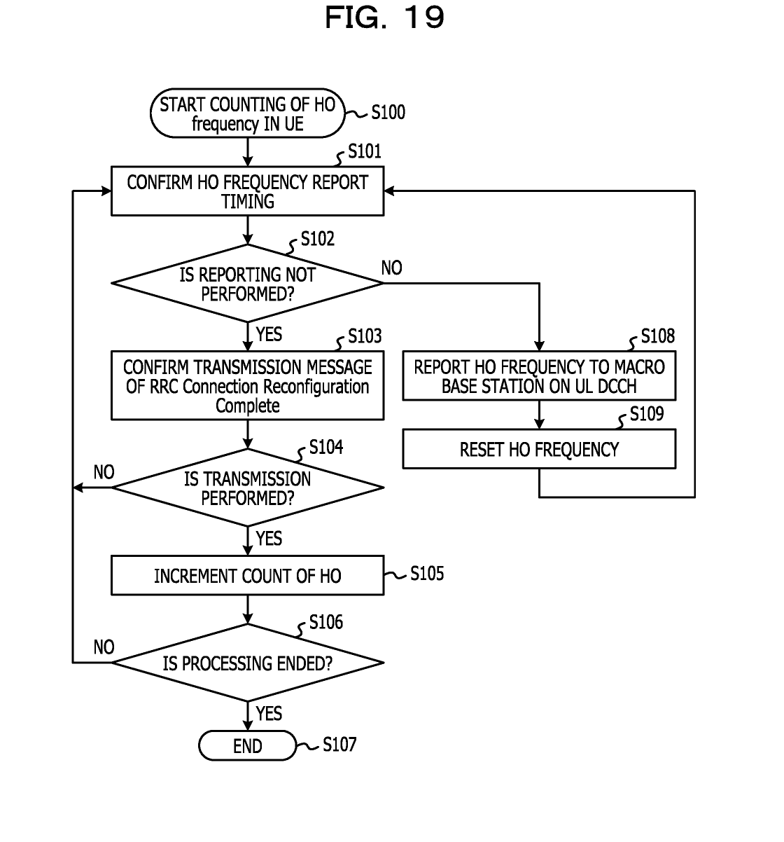

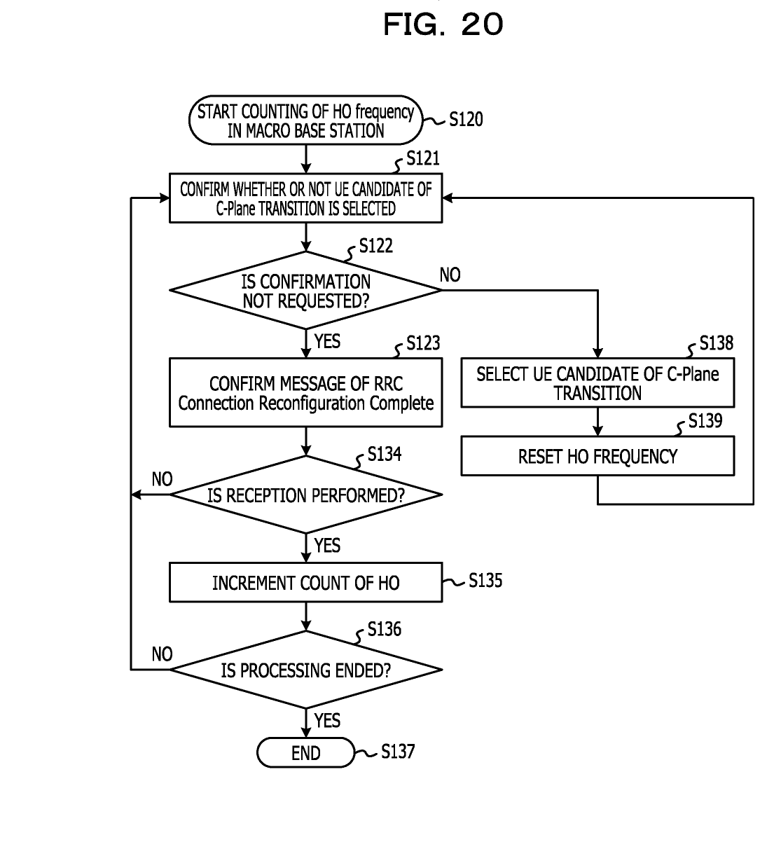

Narrowing may be performed by using other conditions (YES in S30, S32). This method will be described with reference to FIGS. 19 and 20.

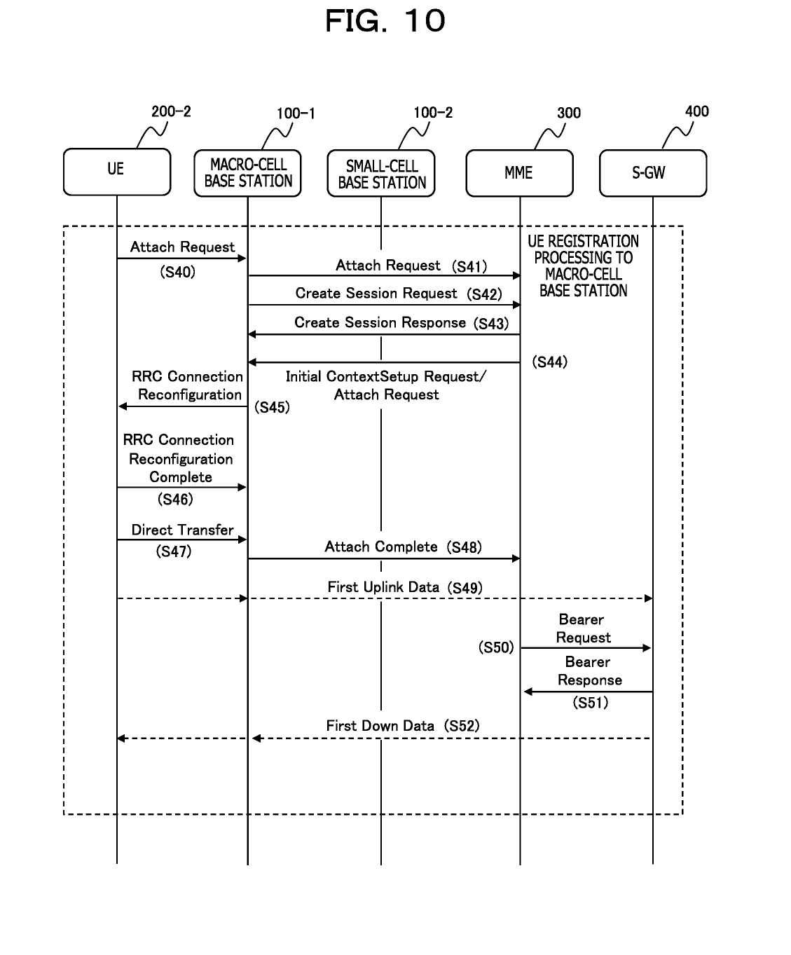

If the narrowing method is selected, the macro-cell base station 100-1 determines whether or not the terminal 200-2 is set as a transition target of the C-Plane processing (S26). Details of the determination method will be described later with reference to FIGS. 10 to 13.

When the terminal 200-2 is set as the transition target of the C-Plane processing (YES in S27), the macro-cell base station 100-1 performs transition of the C-Plane processing and ends a series of processes (S28). When the terminal 200-2 is not set as the transition target of the C-Plane processing (NO in S27), the macro-cell base station 100-1 causes the process to proceed to S21 and repeats the above-described processes.

FIGS. 10 to 13 are sequence diagrams illustrating the operation example of the C-Plane processing transition. FIGS. 10 to 13 illustrate details of the processes of S26 and S27 in FIG. 9, for example.

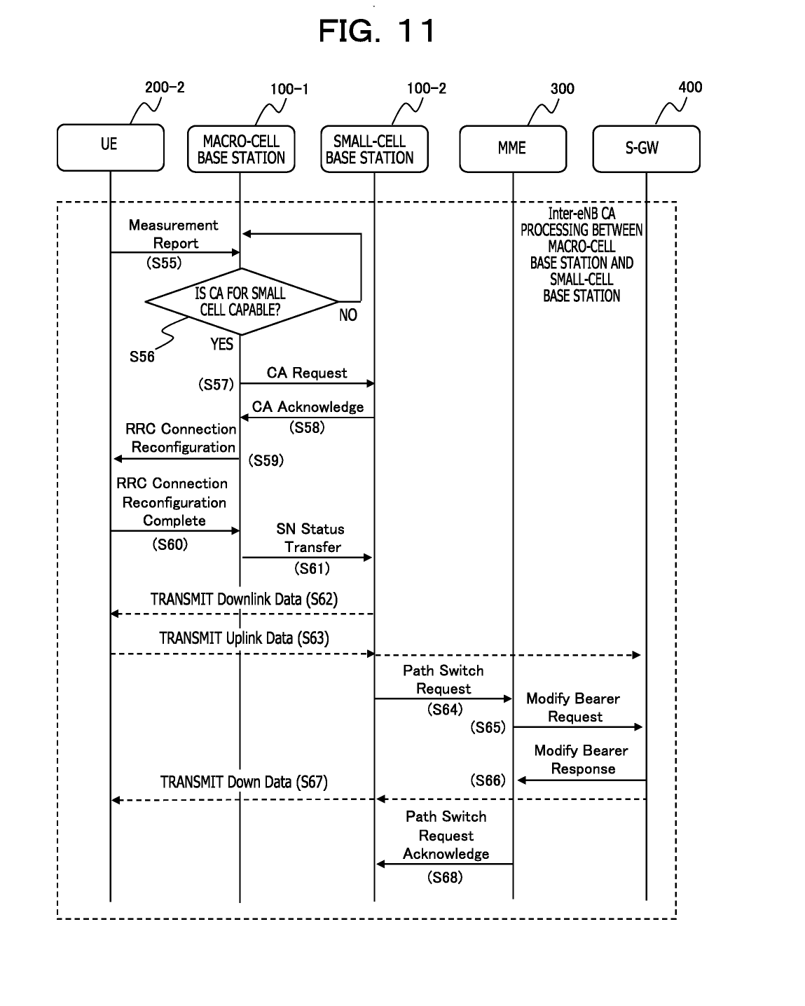

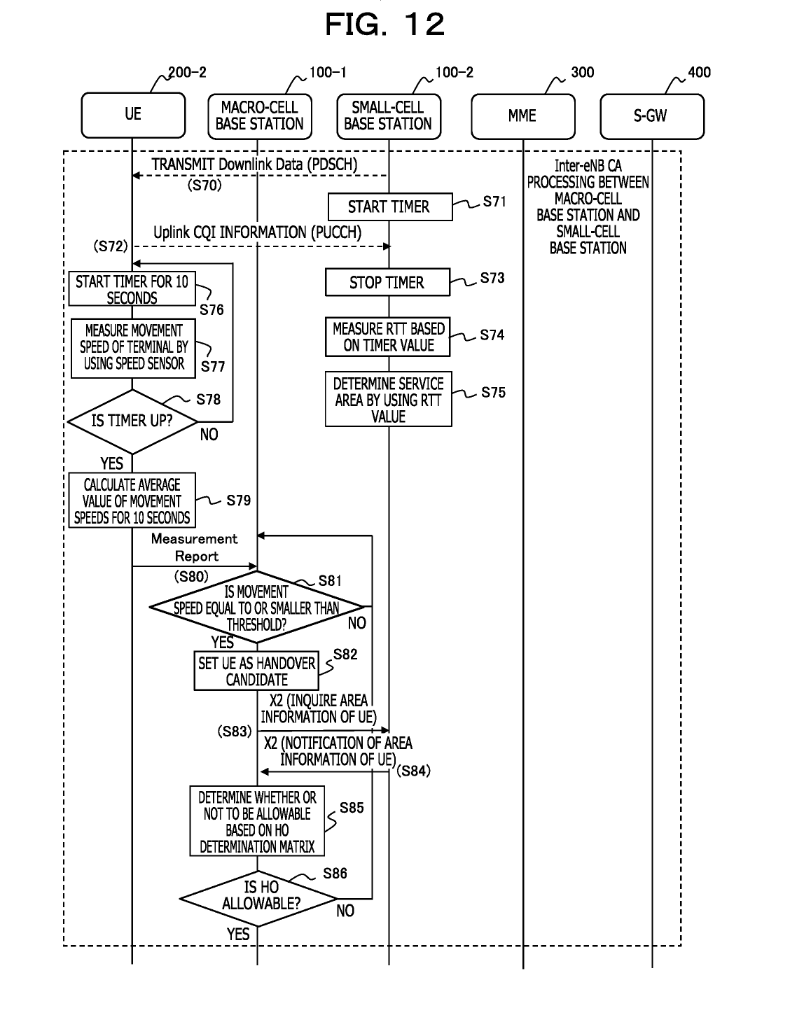

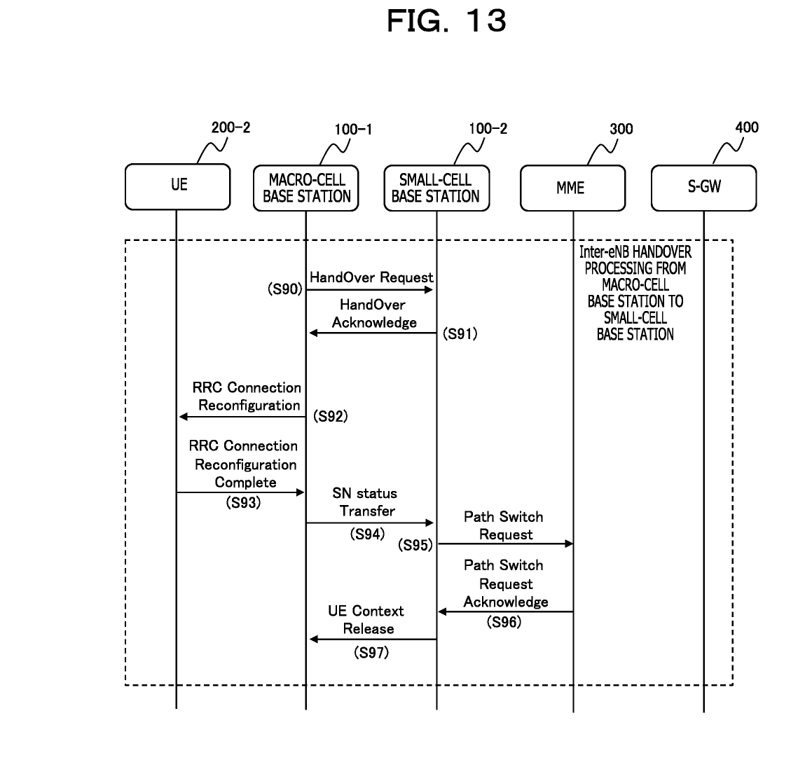

As a whole, the processes are performed in an order of 1) registration processing of the terminal 200-2 to the macro-cell base station 100-1 (FIG. 10), 2) setting processing for CA between the macro-cell base station 100-1 and the small-cell base station 100-2 (FIG. 11), 3) narrowing processing according to the selected narrowing method (or C-Plane transition determination processing) (FIG. 12), and 4) transition processing of the C-Plane at last (FIG. 13). The processes will be described below in this order.

2.1 Registration Processing to Macro-Cell Base Station

FIG. 10 illustrates an example of the registration processing to the macro-cell base station 100-1. The terminal 200-2 transmits Attach Request to the macro-cell base station 100-1 (S40). This transmission causes the terminal 200-2 to request registration (or connection) to the macro-cell base station 100-1.

Then, the macro-cell base station 100-1 transmits Attach Request to the MME 300 (S41). For example, the macro-cell base station 100-1 transmits the request and thus requests setting of the C-Plane for the terminal 200-1 to the MME 300.

Then, the macro-cell base station 100-1 transmits Create Session Request to the MME 300 (S42). For example, the macro-cell base station 100-1 requests setting of the U-Plane for the terminal 200-1 to the MME 300.

Then, the MME 300 transmits Create Session Response to the macro-cell base station 100-1 (S43). For example, the MME 300 transmits a response to Create Session Request to the macro-cell base station 100-1.

Then, the MME 300 transmits Initial ContextSetup Request/Attach Accept to the macro-cell base station 100-1 (S44). For example, the MME 300 transmits a response message indicating permission for the connection request to the macro-cell base station 100-1.

Then, the macro-cell base station 100-1 transmits RRC Connection Reconfiguration to the terminal 200-2 (S45). For example, the macro-cell base station 100-1 transmits a response message indicating permission for the connection request (S40) to the terminal 200-2.

Then, the terminal 200-2 transmits RRC Connection Reconfiguration Complete to the macro-cell base station 100-1 (S46). For example, the terminal 200-2 requests the U-Plane to be used to the macro-cell base station 100-1 allowed to be connected (S46).

Then, the terminal 200-2 transmits Direct Transfer to the macro-cell base station 100-1 (S47). For example, the terminal 200-2 declares using of a radio section between the terminal 200-2 and the macro-cell base station 100-1 to the macro-cell base station 100-1.

Then, the macro-cell base station 100-1 transmits Attach Complete to the MME 300 (S48). For example, the macro-cell base station 100-1 notifies the MME 300 of completion of connection processing with the terminal 200-2.

Then, the terminal 200-2 transmits user data to the macro-cell base station 100-1, and the macro-cell base station 100-1 transmits the user data to the S-GW 400 (S49).

The MME 300 receives Attach Complete, sets an SRB of the terminal 200-2 and transmits Bearer Request to the S-GW 400 so as to request setting of a DRB for the terminal 200-2 to the S-GW 400 (S50).

For example, as illustrated in FIG. 16, the MME 300 sets an SRB ID “bbb” for the ID “xxx” of the terminal 200-2 and the ID “yyy” of the macro-cell base station 100-1. The MME 300 may obtain the IDs of the terminal 200-2 and the macro-cell base station 100-1 in S40, S41, and the like, for example. Setting of the SRB as illustrated in FIG. 16 causes, for example, a path for the C-Plane from the terminal 200-2 to the S-GW 400 through the macro-cell base station 100-1 to be set. The control signal is exchanged by using the path.

Returning to FIG. 10, if Bearer Request is received, the S-GW 400 sets a DRB for the terminal 200-1 and transmits Bearer Response to the MME 300 (S51). The S-GW 400 sets the DRB, for example, based on the IDs and the like of the macro-cell base station 100-1 and the terminal 200-2, which are included in Bearer Request, and sets each of the IDs as illustrated in FIG. 16. Thus, for example, a path for the U-Plane from the terminal 200-2 to the S-GW 400 through the macro-cell base station 100-1 is set. The user data is exchanges by using the path. Information regarding the DRB which is set by the S-GW 400 may be transmitted to the MME 300 by Bearer Response (S51).

Returning to FIG. 10, then, the S-GW 400 transmits the user data to the macro-cell base station 100-1 in accordance with the set DRB, and the macro-cell base station 100-1 transmits the user data to the terminal 200-2 (S52).

2.2 Setting Processing of CA Between Base Stations

FIG. 11 illustrates an example of the setting processing of CA between the base stations. The process continues from the process of FIG. 10.

The terminal 200-2 transmits Measurement Report to the macro-cell base station 100-1 (S55). For example, the terminal 200-2 requests performing of CA between the base stations by transmitting Measurement Report.

Then, the macro-cell base station 100-1 determines whether or not performing of CA between the base stations for the small-cell base station 100-2 is capable (S56). For example, the macro-cell base station 100-1 determines whether or not an installation location of the small-cell base station 100-2 is in a range of the service area 100-M of the macro-cell base station 100-1.

When it is determined that performing of CA between the base stations for the small-cell base station 100-2 is impossible (NO in S56), the macro-cell base station 100-1 causes the process to proceed to S56 and repeats the above-described processes.

When it is determined that performing of CA between the base stations for the small-cell base station 100-2 is capable (YES in S56), the macro-cell base station 100-1 transmits CA Request relating to CA between the base stations to the small-cell base station 100-2 (S57). For example, the macro-cell base station 100-1 requests performing of CA between the base stations to the small-cell base station 100-2.

The small-cell base station 100-2 which receives CA Request transmits CA Acknowledge to the macro-cell base station 100-1 (S58). For example, the small-cell base station 100-2 notifies the macro-cell base station 100-1 to permit CA between the base stations.

Then, the macro-cell base station 100-1 transmits RRC Connection Reconfiguration to the terminal 200-2 (S59). For example, the macro-cell base station 100-1 notifies the terminal 200-2 to permit the request for CA between the base stations.

Then, the terminal 200-2 transmits RRC Connection Reconfiguration Complete to the macro-cell base station 100-1 (S60). For example, the terminal 200-2 notifies the macro-cell base station 100-1 of the U-Plane to be used for the small-cell base station 100-2.

Then, the macro-cell base station 100-1 transmits SN Status Transfer to the small-cell base station 100-2 (S61). For example, the macro-cell base station 100-1 transmits information regarding CA between the base stations to the small-cell base station 100-2.

Then, the small-cell base station 100-2 transmits the user data to the terminal 200-2 (S62). The terminal 200-2 transmits the user data to the small-cell base station 100-2 (S63).

Next, the small-cell base station 100-2 transmits Path Switch Request to the MME 300 (S64). For example, the small-cell base station 100-2 requests performing of CA between the base stations with the macro-cell base station 100-1 to the MME 300 by transmitting a path change request to the MME 300. The small-cell base station 100-2 may transmit Path Switch Request by using reception of CA Request (S57), SN Status Transfer (S61), or the user data (S63) as a trigger.

Then, the MME 300 transmits Modify Bearer Request to the S-GW 400 (S65). For example, the MME 300 requests setting of the DRB between the small-cell base station 100-2 and the terminal 200-2 to the S-GW 400.

In this process (S65), the MME 300 may cause information regarding the set SRB to be included in Modify Bearer Request and transmit the information to the S-GW 400. The S-GW 400 may exchange the control signal with the terminal 200-2 in accordance with the information regarding the set SRB.

Then, the S-GW 400 performs setting relating to the DRB of the terminal 200-2 and transmits Modify Bearer Response to the MME 300 (S66).

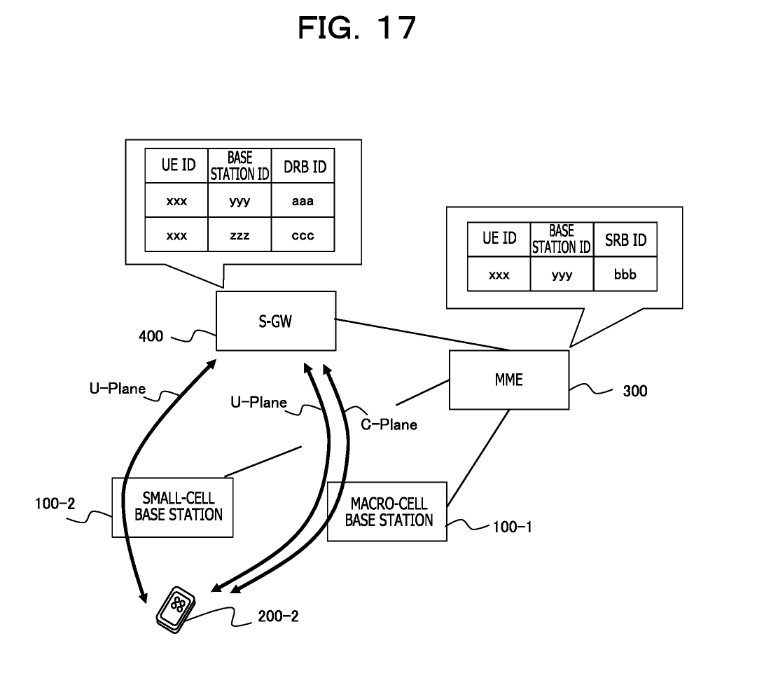

FIG. 17 illustrates a setting example of the DRB and the SRB after the DRB is set by the terminal 200-2. As illustrated in FIG. 17, the S-GW 400 newly sets a DRB ID “ccc” for the ID “xxx” of the terminal 200-2, the ID “zzz” of the small-cell base station 100-2. Thus, for example, a path for the U-Plane from the terminal 200-2 to the S-GW 400 through the small-cell base station 100-2 may be added, and a state where CA between the base stations is capable may occur.

Returning to FIG. 11, then, the S-GW 400 transmits user data to the small-cell base station 100-2 in accordance with the set DRB, and the small-cell base station 100-2 transmits the user data to the terminal 200-2 (S67). In this case, the S-GW 400 may transmit the user data to the macro-cell base station 100-1 in accordance with the set DRB.

Then, the MME 300 transmits Path Switch Request Acknowledge to the small-cell base station 100-2 (S68). For example, the MME 300 transmits a permission response message to the path change request (S64) to the small-cell base station 100-2.

2.3 Narrowing Processing (or Transition Determination Processing of C-Plane)

FIG. 12 is a diagram illustrating an example of transition determination processing of the C-Plane. This processing is performed after the setting processing (for example, FIG. 11) of CA between the base stations is performed.

As described above, the narrowing processing is performed based on determination of a position of the terminal 200-2 (“narrowing and mixing of UE locations”) and mobility of the terminal 200-2 (“narrowing of UE mobility”). Position determination is performed in the small-cell base station 100-2 and corresponds to the processes of S71 to S75. Mobility determination is performed in the macro-cell base station 100-1 and corresponds to the processes of S76 to S79.

The position determination is performed as follows. That is, when user data is transmitted to the terminal 200-2, the small-cell base station 100-2 starts a timer (S70, S71). For example, the RTT measurement unit 137 of the small-cell base station 100-2 starts the timer from a point of time when a baseband signal is transmitted to the terminal 200-2 from the transmission baseband unit 131-1.

Then, the small-cell base station 100-2 receives a channel quality indictor (CQI or transmission quality) for the transmitted user data (S70) (S72) and stops the timer at a time of reception (S73). For example, the RTT measurement unit 137 stops the timer at a point of time when a CQI signal is received from the reception baseband unit 131-2.

Then, the small-cell base station 100-2 measures an RTT value based on a measured timer value (S74). For example, the RTT measurement unit 137 measures a period from a start of the timer to a stop of the timer, and sets a half of the period (or half time in transmission and reception) as an RTT. In this case, the RTT measurement unit 137 may measure the RTT considering an offset value, an offset frame, or the like for a slot position of the user data in a radio frame.

Then, the small-cell base station 100-2 determines the service area 100-S of the small-cell base station 100-2 in which the terminal 200-2 stays, by using the RTT value (S75).

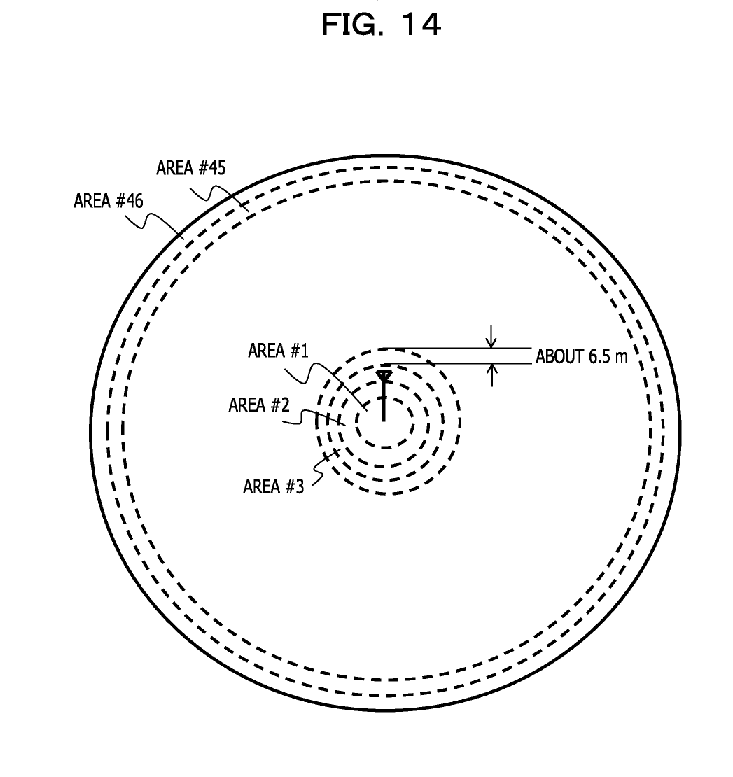

For example, a position of the terminal 200-2 staying in the service area 100-S is determined as follows. That is, the small-cell base station 100-2 and the terminal 200 perform sampling on a radio signal which is transmitted and received, at a sampling frequency of 30.72 MHz. In this case, a transmission period of time corresponding to one cycle of the radio signal is 32.55 ns (=1/30.72M). If a transmission period of time of an electromagnetic wave in the air is set to 5 ns/m, accuracy of about 6.5 m (≅32.55/5) for the radio signal may be secured. If the radius of the service area 100-S is set to 300 m, the radium of the service area 100-S is divided into 46 (≅300/6.5) areas, and the small-cell base station 100-2 may determine whether or not the terminal 200-2 is positioned in the divided areas. FIG. 14 illustrates a division example of the service area 100-S, in which division is performed in this manner. For example, the RTT measurement unit 137 calculates a straight distance (=5 ns×RTT) from the small-cell base station 100-2 to the terminal 200-2, based on the RTT value, and calculates a position of the calculated straight distance in the 46 divided areas. Thus, the RTT measurement unit 137 outputs the calculated position information (for example, the area #1, the area #2, and the like as illustrated in FIG. 14) to the control unit 134. The control unit 134 temporarily stores the position information in an internal memory and the like. Accordingly, the small-cell base station 100-2 can acquire a position of the terminal 200-2.

Returning to FIG. 12, after the CQI information is transmitted to the small-cell base station 100-2 (S72), the terminal 200-2 operates the timer for 10 seconds (S76). For example, the control unit 233 of the terminal 200-2 performs this processing by holding the timer therein and operating the timer.

Then, the terminal 200-2 measures a movement speed of the terminal 200-2 by using the speed sensor 232 (S77).

Then, the terminal 200-2 determines whether or not 10 seconds elapses (S78). When 10 seconds does not elapse (NO in S78), the terminal 200-2 causes the process to proceed to S76 and repeats the above-described processes.

When 10 seconds elapses (YES in S78), the terminal 200-2 calculates an average value of movement speeds for 10 seconds (S79). For example, the speed sensor 232 immediately outputs the measured movement speed to the control unit 233 and the control unit 233 calculates the average value of movement speeds for 10 seconds.

Then, the terminal 200-2 transmits Measurement Report to the macro-cell base station 100-1 (S80). For example, the terminal 200-2 transmits a movement average speed to the macro-cell base station 100-1 by using Measurement Report. For example, the control unit 233 generates Measurement Report including the average value of the calculated movement speeds, and instructs the baseband unit 220 and the wireless unit 210 to transmit generated Measurement Report.

If Measurement Report is received (S80), the macro-cell base station 100-1 determines whether or not the movement speed of the terminal 200-2 is equal to or faster than a speed threshold (S81). For example, the control unit 125 of the macro-cell base station 100-1 reads a movement speed threshold stored in the memory 126, and performs determination by comparing the movement speed threshold and a movement speed average included in Measurement Report.

When the movement speed is faster than the speed threshold (NO in S81), the macro-cell base station 100-1 causes the process to proceed to S80 and repeats the above-described processes.

When the movement speed is equal to or less than the speed threshold (YES in S81), the macro-cell base station 100-1 sets the terminal 200-2 as a C-Plane processing transition target terminal candidate (S82). For example, when the movement speed of the terminal 200-2 is equal to or less than the movement speed threshold, the control unit 125 stores information of the terminal 200-2 as the C-Plane processing transition target terminal candidate, in the memory 126.

Then, the macro-cell base station 100-1 inquires a position of the terminal 200-2 to the small-cell base station 100-2 by using the X2 interface (S83).

The small-cell base station 100-2 notifies the macro-cell base station 100-1 of the position information of the terminal 200-2 as a response to the inquiry (S83) of the position of the terminal 200-2 (S84). For example, the control unit 134 of the small-cell base station 100-2 reads the position information (S75, for example, area #1 and the like) of the terminal 200-2, which is stored in the memory 136, and transmits the read position information to the macro-cell base station 100-1 through the transmission channel interface unit 132.

Then, the macro-cell base station 100-1 determines whether or not the C-Plane is transitioned, based on the mobility (or movement speed average value (S79)) of the terminal 200-2 and the position (or position information (S75)) of the terminal 200-2 (S85). In the second embodiment, the macro-cell base station 100-1 performs determination by using the HO determination matrix.

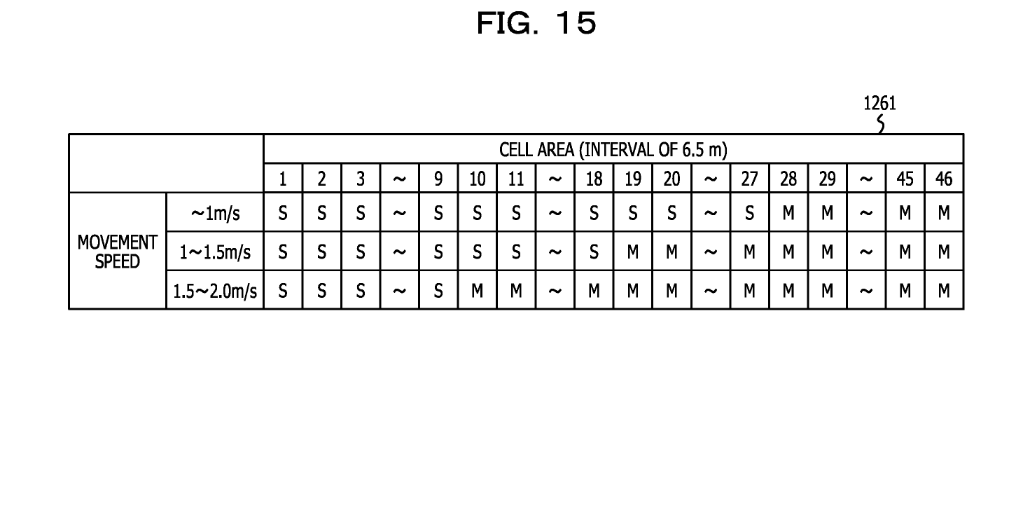

FIG. 15 is a diagram illustrating an example of the HO determination matrix 1261. For example, the HO determination matrix 1261 is stored in the memory 126 of the macro-cell base station 100-1. The HO determination matrix 1261 has an item of “cell area” and an item of “movement speed”. For example, the “cell area” corresponds to the position information of the terminal 200-2, and the “movement speed” corresponds to the movement speed average value of the terminal 200-2. In the HO determination matrix 1261, “S” and “M” are stored in correspondence with the two items. “S” indicates handover to the small-cell base station 100-2, for example. “M” indicates that handover to the small-cell base station 100-2 is not performed and the terminal 200-2 is held to the macro-cell base station 100-1, for example.

For example, the control unit 125 acquires the corresponding items “S” or “M” of the HO determination matrix 1261, based on the movement speed average value (S80) acquired from the terminal 200-2 and the position information (S84) of the terminal 200-2 acquired from the small-cell base station 100-2. In a case of “S”, the control unit 125 determines that the C-Plane transition processing is performed to the small-cell base station 100-2. In a case of “M”, the control unit 125 determines that the transition processing of the C-Plane is not performed.

The HO determination matrix 1261 illustrated in FIG. 15 is as follows, for example.

That is, the terminal 200-2 which stays at a cell edge (area number “46”, “45”, and the like) in the service area 100-S of the small-cell base station 100-2 has a probability of moving the macro-cell base station 100-1 to the service area 100-M, higher than that in other cases regardless of the movement speed. Thus, the C-Plane processing of the terminal 200-2 which stays at the cell edge in the service area 100-S is held to the macro-cell base station 100-1.

The terminal 200-2 which stays at the center (area number “1”, “2”, and the like) of the service area 100-S of the small-cell base station 100-2 has a probability of staying in the service area 100-S for a period which is equal to or longer than the predetermined period of time, higher than that in other cases regardless of the movement speed. Thus, the C-Plane processing of such a terminal 200-2 is transitioned to the small-cell base station 100-2. It is possible to reduce a C-Plane processing load of the macro-cell base station 100-1 and to avoid occurrence of congestion in the C-Plane processing by transitioning the C-Plane processing to the small-cell base station 100-2 from the macro-cell base station 100-1.

When the movement speed is slower than that in other cases, the C-Plane processing of the terminal 200-2 in the vicinity (area number “18”, “19”, and the like) of the intermediate position of the service area 100-S is transitioned to the small-cell base station 100-2. This is, for example, because the terminal 200-2 staying at such a position has a probability of staying in the service area 100-S for a period which is equal to or longer than the predetermined period of time, higher than that in other cases.

When the movement speed is slower than that in other cases in the vicinity of the intermediate position of the service area 100-S, the C-Plane processing of the terminal 200-2 is not transitioned and the terminal 200-2 is held to be under the macro-cell base station 100-1. This is, for example, because the terminal 200-2 staying at such a position has a probability of moving the terminal 200-2 from the service area 100-S of the small-cell base station 100-2 to the service area 100-M of the macro-cell base station 100-1, higher than that in other cases.

Returning to FIG. 12, when it is determined that handover is performed, that is, the C-Plane of the terminal 200-2 is transitioned to the small-cell base station 100-2, based on the HO determination matrix 1261 (YES in S86), the macro-cell base station 100-1 causes the process to proceed to the processes of FIG. 13.

The macro-cell base station 100-1 does not perform handover, based on the HO determination matrix 1261. That is, when it is determined that the C-Plane processing is not transitioned (NO in S86), the macro-cell base station 100-1 causes the process to proceed to S80 and repeats the above-described processes.

2.4 Transition Processing of C-Plane

FIG. 13 illustrates transition processing of the C-Plane. This processing is realized through handover (which may refer to “HO” below) processing for the terminal 200-2 from the macro-cell base station 100-1 to the small-cell base station 100-2.

The macro-cell base station 100-1 transmits HandOver Request to the small-cell base station 100-2 (S90). For example, the macro-cell base station 100-1 requests transition of the C-Plane processing to the small-cell base station 100-2. Such a request is generated, for example, by the control unit 125 in the macro-cell base station 100-1 and is transmitted to the small-cell base station 100-2 through the transmission channel interface unit 122.

Then, the small-cell base station 100-2 transmits HandOver Acknowledge to the macro-cell base station 100-1 (S91). For example, the small-cell base station 100-2 transmits a permission response to the transition request of the C-Plane processing to the macro-cell base station 100-1. The permission response is used for permitting the transition request.

Then, the macro-cell base station 100-1 transmits RRC Connection Reconfiguration to the terminal 200-2 (S92). For example, the macro-cell base station 100-1 notifies the terminal 200-2 to transition the C-Plane processing to the small-cell base station 100-2 from the macro-cell base station 100-1.

Then, the terminal 200-2 transmits RRC Connection Reconfiguration Complete to the macro-cell base station 100-1 (S93).

Then, the macro-cell base station 100-1 transmits SN status Transfer to the small-cell base station 100-2 (S94). For example, the macro-cell base station 100-1 notifies the small-cell base station 100-2 of information regarding handover (information regarding the ID of the terminal 200-2 or transmission packets, and the like).

Then, the small-cell base station 100-2 transmits Path Switch Request to the MME 300 (S95). For example, the small-cell base station 100-2 requests the C-Plane processing of the terminal 200-2 to the MME 300 so as to be set in the small-cell base station 100-2.

For example, a request is performed by Path Switch Request. The request indicates that the small-cell base station 100-2 transitions the C-Plane processing for the terminal 200-2 to the small-cell base station 100-2 from the macro-cell base station 100-1. In this case, the small-cell base station 100-2 notifies the MME 300 of the transition request by using the handover request (S90) or reception of notification (S94) of information regarding handover as a trigger. Thus, the macro-cell base station 100-1 requests transition of the C-Plane processing to the small-cell base station 100-2, to the MME 300 by the handover request or the notification of the information regarding handover. These messages (S90 or S94 and S95) represent a request message for requesting transition of the C-Plane processing, for example.

Then, the MME 300 changes the setting of the SRB so as to cause the C-Plane to be transitioned to the small-cell base station 100-2, and transmits Path Switch Request Acknowledge to the small-cell base station 100-2 (S96). For example, the MME 300 changes the setting of the SRB of the terminal 200-2 so as to be a path from the terminal 200-2 through the macro-cell base station 100-1, and be a path through the small-cell base station 100-2.

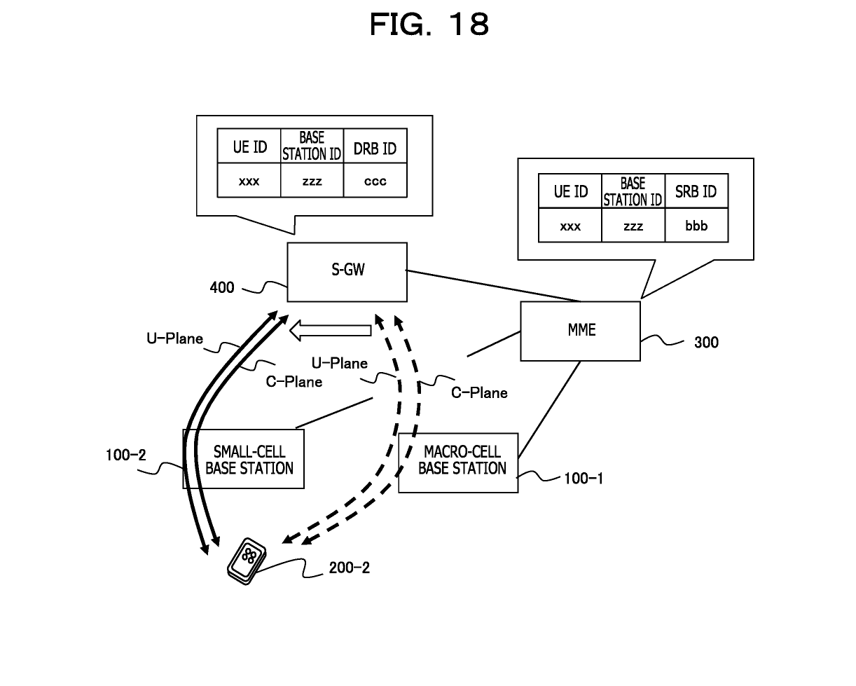

FIG. 18 illustrates a setting example of the SRB and the DRB after the C-Plane processing is transitioned. As illustrated in FIG. 18, regarding the SRB, the SRB ID “bbb” is set for the ID “xxx” of the terminal 200-2 and the ID “zzz” of the small-cell base station 100-2. Regarding the DRB, the DRB ID “ccc” is also set for the ID “xxx” of the terminal 200-2, the ID “zzz” of the small-cell base station 100-2. The DRB may be set, for example, by the MME 300 transmitting Modify Bearer Request to the S-GW 400. The above setting is performed, for example, by the control unit 320 of the MME 300.

Returning to FIG. 13, if Path Switch Request Acknowledge is received from the MME 300 (S96), the small-cell base station 100-2 transmits UE Context Release to the macro-cell base station 100-1 (S97). For example, the small-cell base station 100-2 notifies the macro-cell base station 100-1 of ending of transition of the C-Plane processing, and notifies the macro-cell base station 100-1 to enable deletion of information regarding the terminal 200-2 which has been maintained.

2.5 Other Conditions of Narrowing Method

Next, other conditions of the narrowing method will be described. The conditions described herein correspond to “other conditions” (YES in S30, S32) in FIG. 9, for example. For example, in the macro-cell base station 100-1, the terminal 200-2 which is a transition target of the C-Plane processing is set based on the movement speed (for example, S82 in FIG. 12) or is determined based on the HO determination matrix 1261 (for example, S85 in FIG. 12). Here, an example in which such a terminal 200-2 is excluded from the transition target of the C-Plane processing when the terminal 200-2 is selected (for example, S82 or S85 in FIG. 12) will be described. It is possible to reduce, for example, processing load of the macro-cell base station 100-1 by such determination.

For example, when the handover frequency is greater than a predetermined frequency threshold, in such a terminal 200-2, handover from the macro-cell base station 100-1 to the small-cell base station 100-2 or the reverse handover occurs more than that in other cases. In addition, the staying position of the terminal 200-2 is immediately changed in many cases. In the second embodiment, regarding the frequency of handover, the terminal 200-2 which performs repetition the frequency threshold or more times may be excluded from terminals 200-2 which are set as the transition target of the C-Plane processing. Such a terminal 200-2 has a probability of continuously staying in the service area 100-S of the small-cell base station 100-2 for a period which is equal to longer than the predetermined period of time, smaller than that in other cases.

FIG. 19 illustrates an example of calculation processing of the handover frequency. For example, the calculation processing is performed by the control unit 233 of the terminal 200.

If the process is started (S100), the terminal 200 confirms an HO frequency report timing (S101) and determines to perform reporting at the HO frequency report timing (YES in S102). The terminal 200 determines that reporting is not performed at timings other than the HO frequency report timing (NO in S102).

The terminal 200 confirms the HO frequency report timing (YES in S102), and a transmission message of RRC Connection Reconfiguration Complete (S103), and determines whether or not the message is transmitted (S104).

When the message is transmitted, the terminal 200 increments the HO frequency (S105). As the message, a message transmitted when the terminal 200 performs handover is used.

When the message is not transmitted (NO in S104), the terminal 200 causes the process to proceed to S101 and repeats the above-described processes.

If the HO frequency is incremented, the terminal 200 determines whether or not the processing is ended (S106). When the processing is not ended (NO in S106), the terminal 200 causes the process to proceed to S101 and repeats the above-described processes. When the processing is ended (YES in S106), the terminal 200 ends a series of processes.

When the current timing is not the HO frequency report timing (NO in S102), the terminal 200 transmits the HO frequency which is obtained by performing counting until now to the macro-cell base station 100-1 (S108). For example, the terminal 200 transmits the HO frequency by using an uplink dedicated control channel (UL DCCH).

Then, the terminal 200 resets the HO frequency (S109), and causes the process to proceed to S101.

FIG. 20 illustrates an example in which the HO frequency is counted in the macro-cell base station 100-1. In this case, the macro-cell base station 100-1 determines whether or not a selection of the terminal 200 among terminal candidates of the C-Plane processing transition is confirmed (S121, S122), instead of the HO frequency report timing (S102, S103 in FIG. 19). The macro-cell base station 100-1 determines a count timing of the HO frequency at a timing when the selection is confirmed.

Instead of transmission (S104 in FIG. 19) of RRC Connection Reconfiguration Complete, reception (S134) of the message causes the HO frequency to be incremented (S135).

As another example of the narrowing method, it may be determined whether or not the macro-cell base station 100-1 performs transition of the C-Plane processing, based on the attribute of the terminal 200. For example, the macro-cell base station 100-1 may perform determination based on attribute information of the terminal 200 (for example, the person having the terminal 200 is a very important person (VIP) user), which is received as a notification from the terminal 200.

For example, there is an example in which the terminal 200 is a smart phone. The terminal 200 may notify the macro-cell base station 100-1 of being a smart phone as the attribute information. In addition, instead of transmission of a movement speed average value as mobility information by the terminal 200 (S76 to S79 in FIG. 12), the terminal 200 may transmit a fixed value to the macro-cell base station 100-1 such that the transition processing of the C-Plane to the small-cell base station 100-2 is not performed.

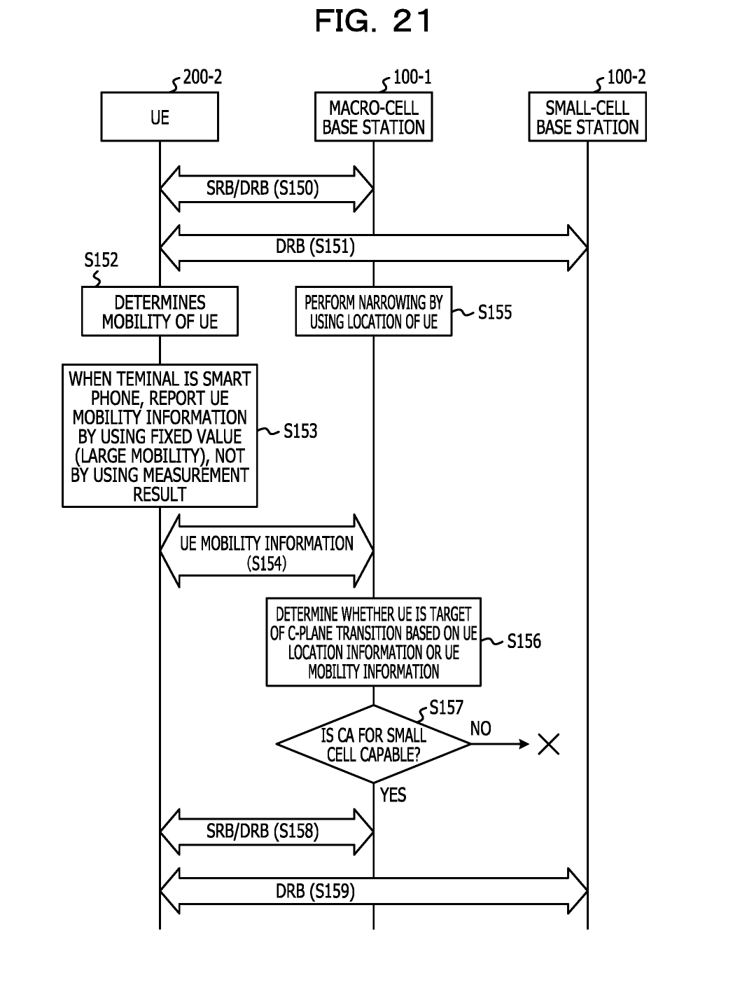

FIG. 21 illustrates an operation example of the case. That is, the terminal 200-2 sets a DRB between two base stations 100-1 and 100-2 by CA between the base stations (S150, S151), and an SRB is set in the macro-cell base station 100-1 as the C/U separation HetNet (S151).

The terminal 200-2 determines the mobility (S152) and reports the fixed value as a smart phone (S153, S154). The macro-cell base station 100-1 acquires a position of the terminal 200-2 (S155). The position may be acquired through the processes of S71 to S75 in FIG. 12.

The macro-cell base station 100-1 determines whether or not the terminal is the C-Plane processing transition target, based on the reported mobility information (for example, fixed value) of the terminal 200-2 and the position information of the terminal 200-2 (S156, S157). In this case, since the fixed value is set to have an extent that transition to the small-cell base station 100-2 is impossible, the macro-cell base station 100-1 determines that transition of the C-Plane processing to the small-cell base station 100-2 is not performed (NO in S157). Thus, the C-Plane processing is maintained to be performed by the macro-cell base station 100-1 (S158, S159).

In this manner, in the second embodiment, the processing quantity for the control signal is equal to or greater than the threshold, and the processing for the control signal of the terminal 200-2 which stays in the service area 100-S for a period which is equal to or longer than the predetermined period of time is transitioned to the small-cell base station 100-2 from the macro-cell base station 100-1. Thus, for example, the C-Plane processing of the terminal 200-2 in the macro-cell base station 100-1 is performed by the small-cell base station 100-2 and the processing load of the C-Plane processing is reduced. Accordingly, it is possible to avoid occurrence of congestion of the C-Plane processing in the macro-cell base station 100-1.

### OTHER EMBODIMENTS

Next, other embodiments will be described.

In the above-described second embodiment, determination based on the RTT value is performed as the position of the terminal 200 (S71 to S75 in FIG. 12). Additionally, for example, a reception power value of a reference signal received by the terminal 200 may be reported to the small-cell base station 100-2, and the areas #1 to #46 in the service area 100-S may be distinguished from each other based on the reception power value. In this case, the macro-cell base station 100-1 may exclude the terminal 200 which is determined to be at an area edge (for example, area #45, #46, or the like) of the service area 100-S, from transition targets of the C-Plane processing.

In addition, instead of the reception power value, the terminal 200-2 may acquire position information of the terminal 200-2 by using Global Positioning System (GPS) and report the position information to the small-cell base station 100-2.

Regarding such position information of the terminal 200-2, the macro-cell base station 100-1 may exclude the terminal 200-2 staying at the cell edge of the service area 100-S of the small-cell base station 100-2 from transition targets of the C-Plane processing.

In the above-described second embodiment, an example of the average movement speed for the mobility information of the terminal 200 is described (S76 to S79 in FIG. 12). Instead of the average movement speed, the mobility information of an UE may be acquired by using a Hold button of the terminal 200-2. For example, the Hold button indicates that the terminal 200-2 stays in the field and does not move. If the Hold button is pressed, the terminal 200-2 may notify the macro-cell base station 100-1 of pressing of the Hold button and a period of time when the Hold button is pressed. In such a case, the macro-cell base station 100-1 expects that such the terminal 200-2 does not move from the small-cell base station 100-2. Thus, it is possible to transition the C-Plane processing to the small-cell base station 100-2 may be performed.

The terminal 200-2 may acquire GPS information, report the acquired GPS information to the macro-cell base station 100-1, and use the reported information in determination of the mobility information of the terminal 200. In addition, information of an acceleration sensor, a pedometer, or the like of the terminal 200-2 may be reported to the macro-cell base station 100-1 as the mobility information of the terminal 200.

In the second embodiment, a case where the C-Plane processing of the terminal 200-2 is transitioned to the small-cell base station 100-2 is described. After transition, in the small-cell base station 100-2, the mobility information of the terminal 200-2 may be acquired or the position information may be acquired in the macro-cell base station 100-1. The transition of the C-Plane processing to the macro-cell base station 100-1 may be determined by using the HO determination matrix 1261. In this case, in the HO determination matrix 1261, “M” indicates performing of HO from the small-cell base station 100-2 to the macro-cell base station 100-1 (transition of the C-Plane processing to the macro-cell base station 100-1), and “S” indicates that HO is not performed (where the C-Plane processing is still performed in the small-cell base station 100-2) in FIG. 15.

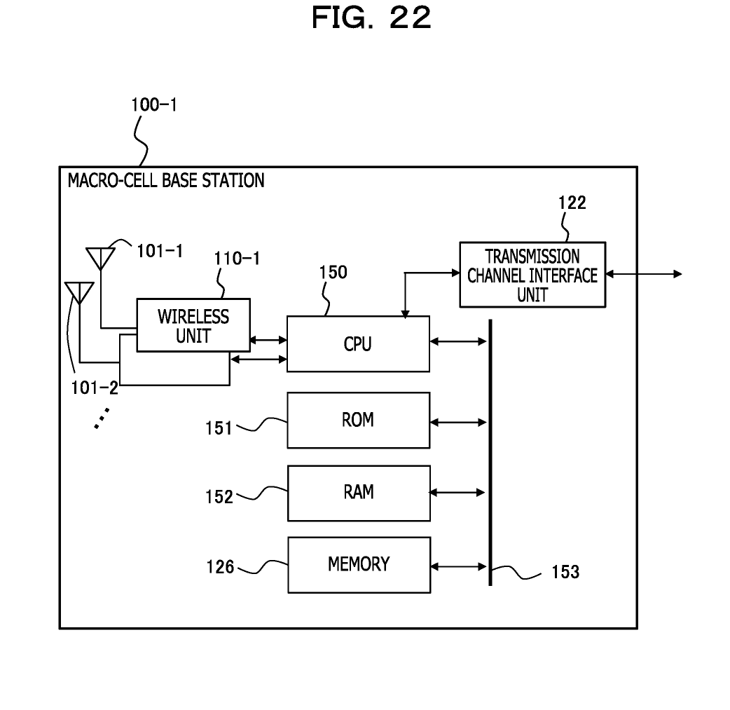

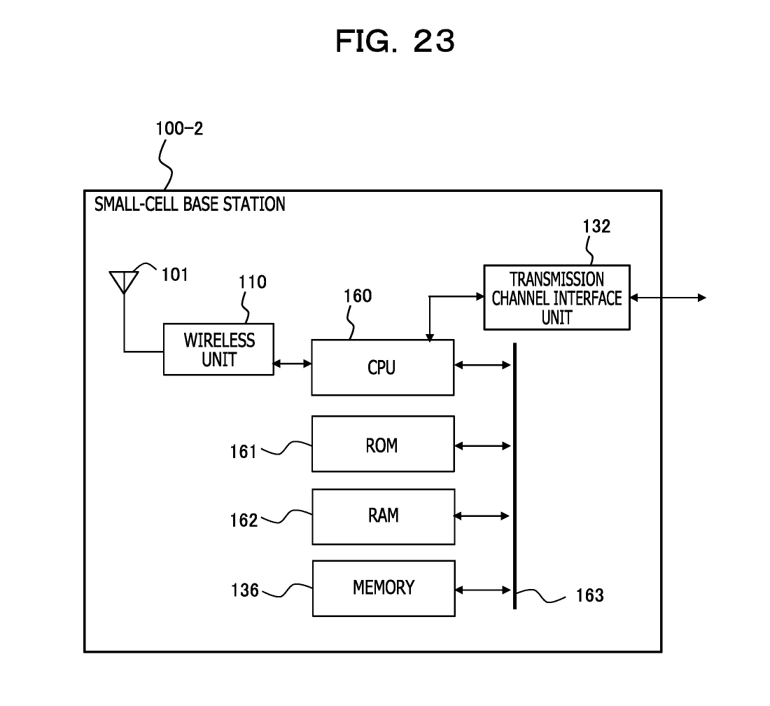

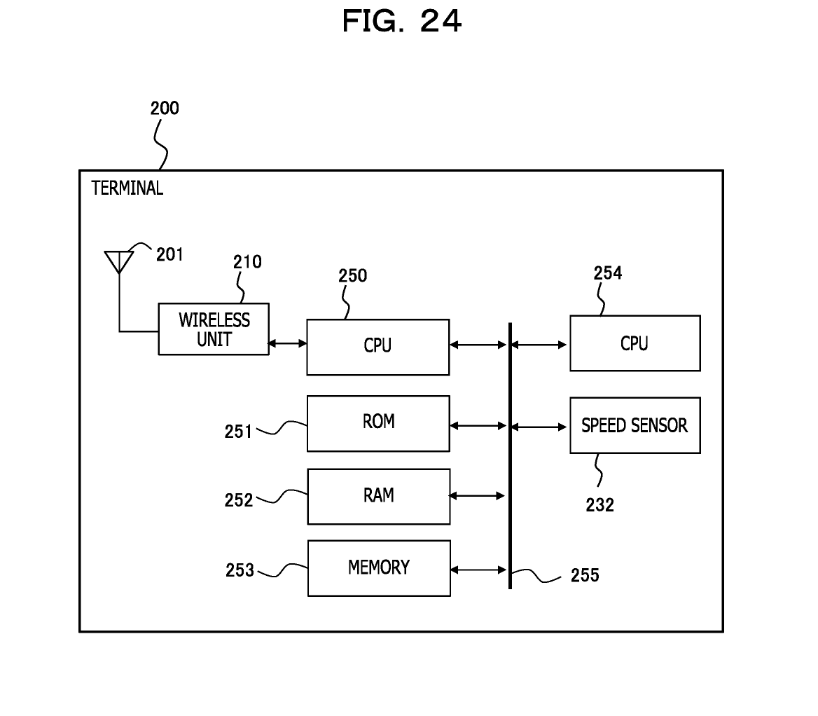

In the second embodiment, the configuration examples of the macro-cell base station 100-1, the small-cell base station 100-2, and the terminal 200 are described. FIG. 22 illustrates a configuration example of hardware of the macro-cell base station 100-1. FIG. 23 illustrates a configuration example of hardware of the small-cell base station 100-2. FIG. 24 illustrates a configuration example of hardware of the terminal 200.

The macro-cell base station 100-1 includes a central processing unit (CPU) 150, a read only memory (ROM) 151, a random access memory (RAM) 152, and an internal bus 153.

The CPU 150 reads a program stored in the ROM 151 and loads the program onto the RAM 152 so as to conduct the loaded program. Thus, the CPU 150 can perform the functions of the baseband unit 121 and the control unit 125. The CPU 150 corresponds to the baseband unit 121 and the control unit 125 in the second embodiment, for example.

The small-cell base station 100-2 includes a CPU 160, a ROM 161, a RAM 162, and an internal bus 163.

The CPU 160 also reads a program stored in the ROM 161 and loads the program onto the RAM 162 so as to conduct the loaded program. Thus, for example, the CPU 160 can perform the functions of the transmission baseband unit 131-1, the reception baseband unit 131-2, the timing control unit 133, the control unit 134, and the RTT measurement unit 137. The CPU 160 corresponds to the two baseband units 131-1 and 131-2, the timing control unit 133, the control unit 134, and the RTT measurement unit 137 in the second embodiment, for example.

The terminal 200 includes a first CPU 250, a ROM 251, a RAM 252, a memory 253, and a second CPU 254, and an internal bus 255.

The first CPU 250 and the second CPU 254 read a program stored in the ROM 251 and loads the program onto the RAM 252 so as to conduct the loaded program. Thus, for example, the first CPU 250 and the second CPU 254 can perform the functions of the baseband unit 220, the control unit 233, the application control unit 221, and the like. For example, the first CPU 250 corresponds to the baseband unit 220 and the control unit 233, and the second CPU 254 corresponds to the application control unit 221.

The CPU 150, 160, and 250 illustrated in FIGS. 22 to 24 may be other controllers such as a micro processing unit (MPU) and a field programmable gate array (FPGA). The control unit 320 of the MME 300 or the control unit 420 and the data transmission unit 440 of the S-GW 400 may be controllers such as the CPU and the MPU.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
an antenna configured to form a second cell; and
a processor configured to:
process a control signal with a terminal that is located in an overlapping area of a first cell and the second cell, the first cell being formed by another base station that processes a data signal with the terminal, and
transfer processing of the control signal with the terminal to the other base station when a load of the processing of the control signal is more than a first threshold in the base station and when the terminal is located in the overlapping area for more than a given length of time.

2. The base station according to claim 1, wherein
the second cell is larger than the first cell and the second cell includes the first cell.

3. The base station according to claim 1, wherein
the processor is configured to determine whether the terminal is located in the overlapping area for more than the given length of time or not based on a location of the terminal and a movement speed of the terminal.

4. The base station according to claim 1, wherein
when the load of the processing of the control signal is more than the first threshold in the base station, the processor is configured to determine whether the terminal is located in the overlapping area for more than the given length of time or not based on a location of the terminal and a movement speed of the terminal.

5. The base station according to claim 3, wherein
the processor is configured to transfer the processing of the control signal with the terminal to the other base station when the terminal locates in a first area far from a center of the first cell with a distance less than a second threshold and when the movement speed of the terminal is less than a third threshold.

6. The base station according to claim 5, wherein
the processor is configured not to transfer the processing of the control signal with the terminal to the other base station when the terminal does not locate in the first area or when the movement speed of the terminal is more than the third threshold.

7. The base station according to claim 3, wherein
the processor is configured to transfer the processing of the control signal with the terminal to the other base station when the terminal locates in a second area far from a center of the second cell with a distance less than a second threshold.

8. The base station according to claim 7, wherein
the processor is configured not to transfer the processing of the control signal with the terminal to the other base station when the terminal locates in a third area far from a edge of the second cell with a distance less than a fourth threshold.

9. The base station according to claim 3, wherein
the location of the terminal is obtained by the other base station by wirelessly communicating with the terminal,
the movement speed of the terminal is obtained by the terminal, and
the processor is configured to receive first information on the location of the terminal from the other base station and second information on the movement speed of the terminal from the terminal.

10. The base station according to claim 1, wherein
the processor is configured to make a determination whether to transfer processing of the control signal with the terminal to the other base station when the load of the processing of the control signal is more than the first threshold in the base station, and not to make the determination when the load of the processing of the control signal is less than the first threshold in the base station.

11. The base station according to claim 1, wherein
the processor is configured not to transfer the processing of the control signal with the terminal to the other base station without determining whether the terminal is located in the overlapping area for more than the given length of time or not when the number of handover of the terminal between the base station and the other base station is more than a fifth threshold.

12. The base station according to claim 1, wherein
the processor is configured to transmit a message requesting to make the base station transfer the processing of the control signal with the terminal to the other base station, to a management apparatus.

13. The base station according to claim 9, wherein
the processor is configured not to transfer the processing of the control signal with the terminal to the other base station when the second information on the movement speed of the terminal includes a fixed value.

14. A wireless communication system comprising:
a base station configured to form a second cell;
another base station configured to form a first cell, the first cell being formed by another base station that processes a data signal with the terminal; and
a terminal located in an overlapping area of a first cell and the second cell,
wherein the base station is configured to:
process a control signal with the terminal, and
transfer processing of the control signal with the terminal to the other base station when a load of the processing of the control signal is more than a first threshold in the base station and when the terminal is located in the overlapping area for more than a given length of time.

15. A wireless communication method comprising:
forming a second cell by a base station;
processing a control signal with a terminal that is located in an overlapping area of a first cell and the second cell, the first cell being formed by another base station that processes a data signal with the terminal; and
transferring processing of the control signal with the terminal to the other base station when a load of the processing of the control signal is more than a first threshold in the base station and when the terminal is located in the overlapping area for more than a given length of time.
